(19) United States
(12) Patent Application Publication
(10) Pub. No.: US 2021/0211247 A1
(43) Pub. Date: Jul. 8, 2021

(54) PRECODING METHOD, DECODING METHOD, TRANSMITTING DEVICE AND RECEIVING DEVICE

(71) Applicant: NTT DOCOMO, INC., Tokyo (JP)

(72) Inventors: Xin Wang, Beijing (CN); Xiaolin Hou, Beijing (CN)

(73) Assignee: NTT DOCOMO, INC., Tokyo (JP)

(21) Appl. No.: 17/057,496

(22) PCT Filed: May 22, 2018
(86) PCT No.: PCT/CN2018/087805

§ 371 Date: Nov. 20, 2020

(51) Int. Cl. H04L 5/00; H04L 1/00

(52) U.S. Cl. CPC H04L 5/0007; H04L 5/0044; H04L 1/0009; H04L 1/0073

(57) ABSTRACT

Embodiments of the present disclosure provide a precoding method, a decoding method, a transmitting device and a receiving device, where the precoding method applied to the transmitting device includes: acquiring data symbols to be transmitted and a transmission layer identifier corresponding to the data symbols to be transmitted; determining a modulo boundary for a precoding modulo operation according to the transmission layer identifier corresponding to the data symbols to be transmitted; processing the data symbols to be transmitted according to the determined modulo boundary to acquire transmission symbols.

### TECHNICAL FIELD

The present application relates to a field of wireless communications, and in particular, to a precoding method, a decoding method, a transmitting device, and a receiving device that may be used in a wireless communication system.

### BACKGROUND

A precoding method can utilize known channel state information to preprocess an initial signal for transmission at a transmitting end, so that the processed transmission signal can adapt to the corresponding channel environment, and increase a degree of matching with the system channel, to facilitate a receiving end to perform better equalization and detection. The precoding method can reduce a bit error rate, obtain better signal-to-noise-ratio gain, and significantly improve system performance.

In the precoding method (for example, a THP non-linear precoding method), it is necessary to eliminate interference between signals through a modulo operation. However, a modulo boundary set according to a current boundary setting method easily causes losses such as modulo loss and power loss and the like, which affects the performance of the communication system.

Therefore, there is a need for a method that can reduce the loss caused by the modulo operation of the precoding method and improve the performance of the communication system.

### SUMMARY OF THE INVENTION

According to one aspect of the present disclosure, there is provided a precoding method applied to a transmitting device, the method comprising: acquiring data symbols to be transmitted and a transmission layer identifier corresponding to the data symbols to be transmitted; determining a modulo boundary for a precoding modulo operation according to the transmission layer identifier corresponding to the data symbols to be transmitted; processing the data symbols to be transmitted according to the determined modulo boundary to acquire transmission symbols.

According to another aspect of the present disclosure, there is provided a decoding method applied to a receiving device, the method comprising: acquiring reception symbols and information about a modulo boundary, the modulo boundary being determined by a transmission layer identifier corresponding to the reception symbols; processing the reception symbols according to the modulo boundary to obtain data symbols to be transmitted.

According to another aspect of the present disclosure, there is provided a precoding method applied to a transmitting device, the method comprising: grouping data symbols to be transmitted; selecting a common modulo vector for each group of data symbols to be transmitted; processing each group of data symbols to be transmitted according to selected common modulo vector to acquire transmission symbols.

According to another aspect of the present disclosure, there is provided a decoding method applied to a receiving device, the method comprising: acquiring reception symbols and information about reception symbol grouping; processing, according to the information about the reception symbol grouping, each group of reception symbols by using a common modulo vector of each group of reception symbols, to acquire data symbols to be transmitted.

According to another aspect of the present disclosure, there is provided a transmitting device, comprising: an acquiring unit configured to acquire data symbols to be transmitted and a transmission layer identifier corresponding to the data symbols to be transmitted; a determining unit configured to determine a modulo boundary for a precoding modulo operation according to the transmission layer identifier corresponding to the data symbols to be transmitted; a processing unit configured to process, according to the determined modulo boundary, the data symbols to be transmitted to acquire transmission symbols.

According to another aspect of the present disclosure, there is provided a receiving device is provided, comprising: an acquiring unit configured to acquire reception symbols and information about a modulo boundary, the modulo boundary being determined by a transmission layer identifier corresponding to the reception symbols; a processing unit configured to process, according to the modulo boundary, the reception symbols to acquire data symbols to be transmitted.

According to another aspect of the present disclosure, there is provided a transmitting device, comprising: a grouping unit configured to group data symbols to be transmitted; a selecting unit configured to select a common modulo vector for each group of data symbols to be transmitted; a processing unit configured to process, according to selected common modulo vector, each group of data symbols to be transmitted to acquire transmission symbols.

According to another aspect of the present disclosure, there is provided a receiving device, comprising: an acquiring unit configured to acquire reception symbols and information about reception symbol grouping; a processing unit configured to process, according to the information about the reception symbol grouping, each group of reception symbols by using a common modulo vector of each group of reception symbols to acquire data symbols to be transmitted.

By using the precoding method, the decoding method, the transmitting device, and the receiving device according to the above aspects of the present disclosure, it is possible to determine a modulo boundary in the modulo operation according to a transmission layer identifier for signal transmission during the precoding process, and the transmission signal is processed according to the determined modulo boundary, so that the receiving device performs the corresponding signal receiving and decoding operations. The method and device in the present disclosure can further reduce losses such as the modulo loss and the power loss brought by the modulo operation to the communication system, and effectively improve the performance of the communication system.

### BRIEF DESCRIPTION OF THE DRAWINGS

The above and other objects, features, and advantages of the present disclosure will become clearer by describing embodiments of the present disclosure in detail with reference to the accompanying drawings.

FIG. 1 shows a system block diagram of a THP precoding used according to one embodiment of the present disclosure;

FIG. 2 (a) shows a schematic diagram of data symbols to be transmitted, FIG. 2 (b) shows a schematic diagram of mapping position after considering interference vectors during successive interference cancellation, and FIG. 2 (c) shows a position of a modulo boundary in the modulo operation, FIG. 2 (d) shows a schematic diagram of mapping position of transmission symbols obtained by performing the modulo operation on symbols after considering the interference vector in FIG. 2 (b);

FIG. 3 (a) shows reception symbols received by a receiving end, and FIG. 3 (b) shows data symbols to be transmitted that are obtained after performing modulo operation on the reception symbols;

FIG. 4 (a) shows a decision region for reception symbols when no modulo operation is performed; FIG. 4 (b) shows the influence on the decision region after the modulo operation;

FIG. 5 shows a flowchart of a precoding method according to one embodiment of the present disclosure;

FIG. 6 shows an example of grouping transmission layer identifiers and determining a modulo boundary according to one embodiment of the present disclosure;

FIG. 7 shows a method for performing precoding by selecting a common modulo vector for one group of data symbols to be transmitted composed of two data symbols to be transmitted according to one embodiment of the present disclosure;

FIG. 8 shows a method for decoding by performing modulo operation on two reception symbols in one group by using a common modulo vector according to one embodiment of the present disclosure;

FIG. 9 shows a flowchart of a decoding method according to one embodiment of the present disclosure;

FIG. 10 shows a flowchart of a precoding method according to one embodiment of the present disclosure;

FIG. 11 shows a flowchart of a decoding method according to one embodiment of the present disclosure;

FIG. 12 shows a structural block diagram of a transmitting device according to one embodiment of the present disclosure;

FIG. 13 shows a structural block diagram of a receiving device according to one embodiment of the present disclosure;

FIG. 14 shows a structural block diagram of a transmitting device according to one embodiment of the present disclosure;

FIG. 15 shows a structural block diagram of a receiving device according to one embodiment of the present disclosure;

FIG. 16 shows a diagram of an example of a hardware structure of a transmitting device and a receiving device involved according to one embodiment of the present disclosure.

### DESCRIPTION OF THE EMBODIMENTS

A precoding method, a decoding method, and corresponding transmitting and receiving devices according to embodiments of the present disclosure will be described below with reference to the accompanying drawings. In the accompanying drawings, the same reference numerals denote the same elements throughout. It should be understood that the embodiments described herein are merely illustrative and should not be construed as limiting the scope of the present disclosure.

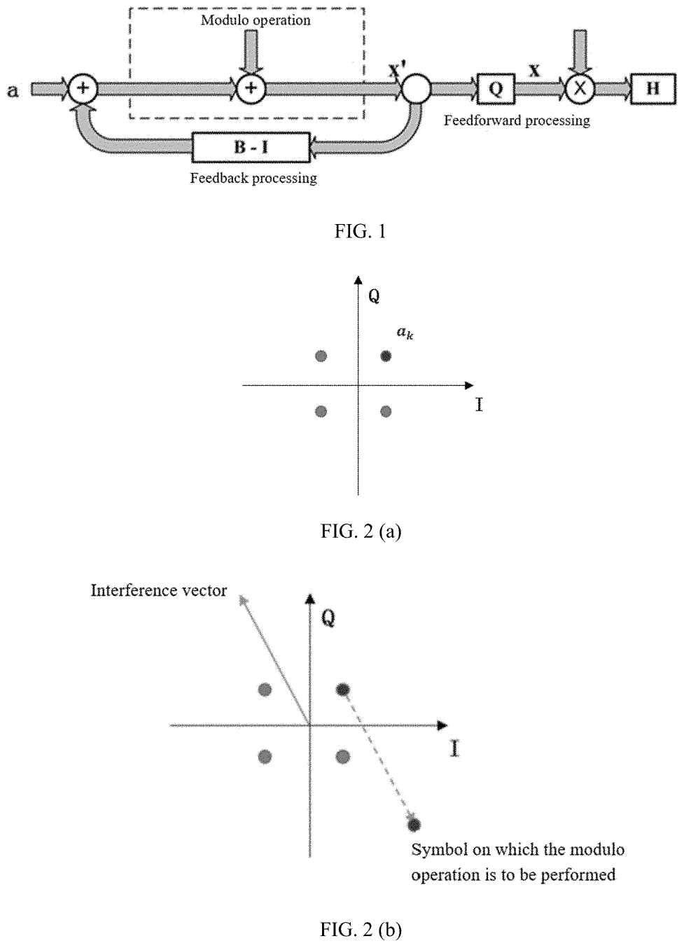

FIG. 1 shows a system block diagram of a non-linear precoding: THP precoding used according to one embodiment of the present disclosure. As shown in FIG. 1, when performing THP precoding, a system of data symbols to be transmitted obtains matrices B and Q according to a channel matrix H, and cancels interference suffered by the data symbol a to be transmitted in advance according to the matrix B in a feedback processing stage, and performs a modulo operation on a after interference cancellation, and obtains a vector X′. The obtained vector X′ is transmitted to a receiving device via the channel H after further feedforward processing and power normalization.

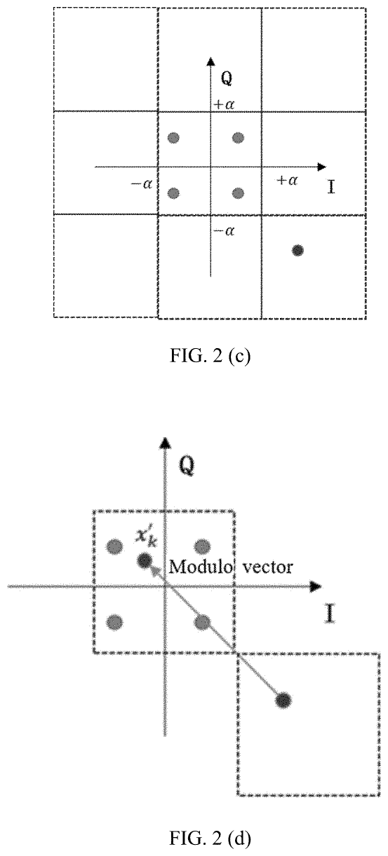

FIG. 2 shows a constellation diagram of the modulo operation on the data symbols to be transmitted in the THP precoding method at a transmitting end. FIG. 2 (a) is a schematic diagram of a data symbol aₖ to be transmitted, and FIG. 2 (b) shows a schematic diagram of a mapping position of symbols on which the modulo operation is to be taken after considering an interference vector during successive interference cancellation. Specifically, symbol positions shown in FIG. 2 (b) are obtained after the data symbols to be transmitted in FIG. 2 (a) are combined with a influence of the interference vector. FIG. 2 (c) shows a position of a modulo boundary α in the modulo operation, and FIG. 2 (d) shows a schematic diagram of a mapping position of a transmission symbol X′ₖ obtained by performing the modulo operation with the modulo boundary in FIG. 2 (c) on a symbol on which the modulo operation is to be performed after considering the interference vector in FIG. 2 (b). As shown in FIG. 2, interference cancellation is first performed on the data symbol aₖ to be transmitted. However, this operation may increase signal power and thus affect signal transmitting. Therefore, a lower power transmission symbol X′ₖ may be subsequently obtained for signal transmitting through the modulo operation.

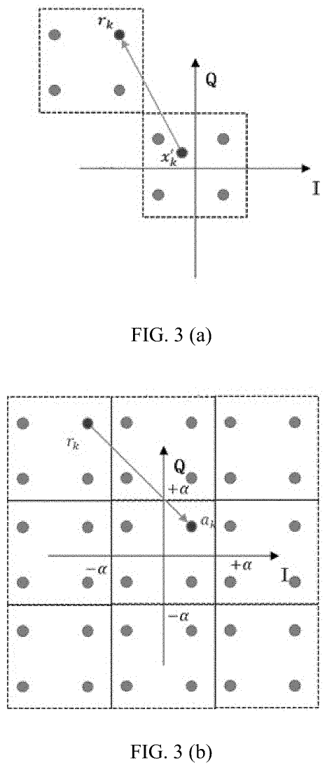

Subsequently, similar operations to the transmitting end will be performed at a receiving end. FIG. 3 shows a constellation diagram of a decoding method at the receiving end. FIG. 3 (a) shows a reception symbol rₖ received by the receiving end and composed of the transmission symbol and the interference vector. FIG. 3 (b) shows a data symbol aₖ to be transmitted obtained by performing the same modulo operation as the transmitting end on the reception symbol rₖ. It can be known from FIG. 3 that after receiving the reception symbol, the receiving end may perform the same modulo operation as the transmitting end, that is, a modulo operation with the same modulo boundary and modulo vector, and can then obtain the data symbol aₖ to be transmitted which is to be decided, so as to accurately receive information transmitted by the transmitting end.

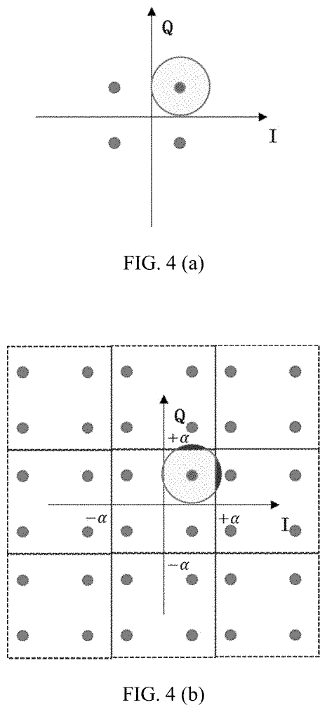

However, in the modulo operation of the above THP method, an effect of signal receiving in the communication system is often affected due to a change in a decision region or a change in an amplitude of the received signal and a model mismatch caused by the change. FIG. 4 illustrates the influence of the modulo operation on the decision region of the precoding method. FIG. 4 (a) shows the decision region for the reception symbols when no modulo operation is performed. It can be seen that when no modulo operation is performed, all the reception symbols in the circle can be correctly detected. FIG. 4 (b) shows the influence on the decision region after performing the modulo operation. According to FIG. 4 (b), considering the change of the signal after the modulo operation, a region where a shaded part around the circle exceeds the modal boundary cannot be detected correctly.

Therefore, the embodiments of the present disclosure provide the following precoding method, decoding method, transmitting device, and receiving device.

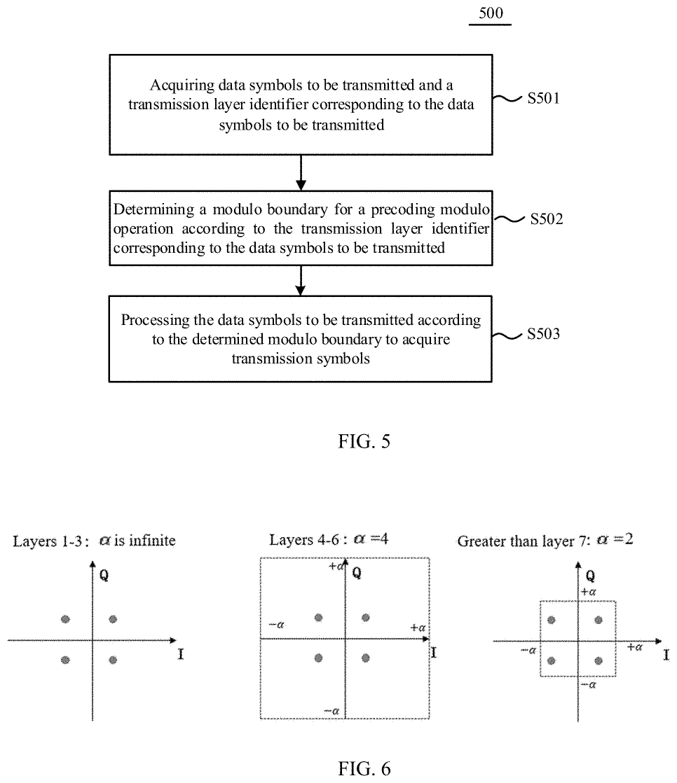

First, a precoding method performed by a transmitting device according to an embodiment of the present disclosure is described with reference to FIG. 5. FIG. 5 shows a flowchart of the precoding method 500. The precoding method in the embodiment of the present disclosure may be applied to non-linear precoding (such as THP precoding, VP precoding, etc.). Furthermore, the transmitting device in the embodiment of the present disclosure may be any communication device, for example, a base station or a user equipment UE, which is not restricted herein.

As shown in FIG. 5, in step S501, data symbols to be transmitted and a transmission layer identifier corresponding to the data symbols to be transmitted are acquired. In this step, the transmitting device may first acquire a data symbol aₖ to be transmitted and a transmission layer identifier corresponding to the data symbol to be transmitted, for subsequent modulo boundary judgment and specific modulo operation.

In step S502, a modulo boundary for the precoding modulo operation is determined according to the transmission layer identifier corresponding to the data symbols to be transmitted.

In this step, considering that different transmission layers have different influences on a power of a transmitted signal, different modulo boundaries may be adaptively determined for signals transmitted on different transmission layers with different transmission layer identifiers. Optionally, considering that as the transmission layer identifier increases, the suffered interference also increases. Therefore, the determined modulo boundary may be gradually reduced. Furthermore, optionally, when the transmission layer identifier is less than or equal to a preset transmission layer identifier, the modulo operation therefore may not be performed on the data symbols to be transmitted, that is, the determined modulo boundary may be considered to be infinite (∞).

When the data transmitted by the transmitting device to the receiving device is transmitted through a plurality of transmission layers, in one example, different modulo boundaries may be determined for each different transmission layer identifier; in another example, the same or different modulo boundaries may be determined for a plurality of transmission layer identifiers, where the multiple transmission layers may be used as one or more transmission layer groups, and accordingly, the modulo boundaries may be determined according to the transmission layer groups. In one example, the determined modulo boundaries for the transmission layer identifiers in the same transmission layer group may be the same. In another example, the determined modulo boundaries may be different in different transmission layer groups. For example, when one or more transmission layer identifiers in one transmission layer group are increased relative to one or more transmission layer identifiers in another transmission layer group, the modulo boundary may be gradually reduced. Considering that the transmission layer group may have a plurality of transmission layer identifiers, therefore, an increase in the transmission layer identifier may be, for example, a maximum transmission layer identifier in one transmission layer group being increased compared with a maximum transmission layer identifier in another transmission layer group, an average transmission layer identifier in one transmission layer group being increased compared with an average transmission layer identifier in another transmission layer group, and one or more transmission layer identifiers in one transmission layer group being increased compared with one or more transmission layer identifiers in another transmission layer group. Optionally, when one or more transmission layer identifiers in the transmission layer group are less than or equal to the preset transmission layer identifier, the modulo operation may not be performed on the data symbols to be transmitted corresponding to the transmission layer symbols in the transmission layer group.

The above manners of determining the modulo boundary for the transmission layer identifier are only examples. In practical applications, any manner of determining the modulo boundary according to the transmission layer identifier or any grouping manner may be used, which is not restricted herein.

FIG. 6 shows an example of grouping the transmission layer identifiers and determining a modulo boundary according to one embodiment of the present disclosure. According to FIG. 6, when the transmission layer identifier in the transmission layer group is 1-3, the modulo operation may not be performed on the data symbols to be transmitted corresponding to the transmission layer identifier in the transmission layer group; when the transmission layer identifier in the transmission layer group is 4-6, the modulo boundary α may be 4, which has a larger modulo boundary than a higher transmission layer identifier; when the transmission layer identifier in the transmission layer group is greater than or equal to 7, the modulo boundary α may be 2, which has a relatively smaller modulo boundary.

In one embodiment, the determined modulo boundary causes the power of the acquired transmission symbols to satisfy a preset condition, after the data symbols to be transmitted corresponding to the transmission layer identifier are processed according to the modulo boundary. For example, a modulo boundary that makes the power of the transmission symbols as small as possible may be selected; or a modulo boundary that satisfies the power of the transmission symbols to be less than a specific power threshold may be selected. When the modulo boundary has several possible values, a value of the possible modulo boundary that minimizes the power of the transmission symbols may be selected.

In one example, a transmission symbol x′ₖ transmitted by the k-th data stream (transmission layer) may be represented by the data symbol aₖ to be transmitted, a modulo operation representation item 2\sqrt{α}(pₖ+jqₖ), and interference vectors

$${\sum }^{k - 1} {b}_{k , l} {{x}_{l}^{′}}_{k - 1}$$

of the 1st to k-lth data streams/transmission layers as:

$${x}_{k}^{′} = {a}_{k} + 2 \sqrt{α} ( {p}_{k} + {{jq}_{k}}^{l = 1} ) - {\sum }_{l = 1} {k}_{k , l} {x}_{l}^{′} ,$$

where pₖ and qₖ are integers, b_{k,j} is an element on the k-th row and the 1-th column in a feedback matrix B, L is a total number of transmission layers used by the transmitting device to transmit data,

$$L = {\sum }_{k = 1}^{K} {N}_{R , k} ,$$

and N_{R,k} is the number of data streams (transmission layers) transmitted to the k-th receiving device.

A specific manner to determine the modulo boundaries for different transmission layer identifiers may be, for example: in the case where the preset transmission layer identifier is set to 1, when the transmission layer identifier is 1, the power σ of an initial signal on which no modulo operation is performed satisfies σ₁²=1, then the modulo operation is not performed on the initial signal corresponding to this transmission layer identifier, and the power is P₁=1. When the transmission layer identifier is not 1, the power of the initial signal on which no modulo operation is performed should satisfy

$${{σ}_{k}}^{2} = {\sum }_{l = 1}^{k - 1} \vert {b}_{k , l} \vert {p}_{l} + 1$$

after considering the influence of the interference vectors, and at this time, a relationship between the power Pₖ and the modulo boundary α may be expressed as:

$${P}_{k} = {{σ}_{k}}^{2} + {\sum }_{m = - ∞}^{+ ∞} \{ 4 {α}^{2} {m}^{2} [ erf ( \frac{α ( 2 m + 1 )}{{σ}_{k}} ) - erf ( \frac{α ( 2 m - 1 )}{{σ}_{k}} ) ] + \frac{4 {σ}_{k} α m}{\sqrt{π}} [ exp ( - \frac{{{α}^{2} ( 2 m + 1 )}^{2}}{{{σ}_{k}}^{2}} ) - exp ( - \frac{{{α}^{2} ( 2 m - 1 )}^{2}}{{{σ}_{k}}^{2}} ) ] \}$$

It can be seen that according to the above relationship between Pₖ and α, in the embodiment of the present disclosure, an α value that makes Pₖ as small as possible may be selected as the modulo boundary. For example, an α value that satisfies Pₖ to be less than a specific power threshold γ may be selected as the modulo boundary. When the α value of the modulo boundary has several possible values, the possible value of α that minimizes Pₖ may be selected as the modulo boundary. The above relationship between Pₖ and a and the selection manner of the α value of the modulo boundary are merely examples. In practical applications, any manner of value selection for the modulo boundary may be adopted.

In step S503, the data symbols to be transmitted are processed according to the determined modulo boundary to acquire transmission symbols.

After the modulo boundary is determined according to the transmission layer identifier, the data symbols to be transmitted may be processed according to the determined modulo boundary. For example, in one example, the modulo operation may not be performed on the data symbols to be transmitted; in another example, the modulo operation may also be performed on the data symbols to be transmitted according to the determined modulo boundary, and a transmission symbol X′ₖ that can be transmitted on a transmission layer having this transmission layer identifier is obtained after a subsequent series of processing. After determining the modulo boundary corresponding to each transmission layer identifier, a corresponding modulo operation may be performed on the data symbols to be transmitted corresponding to the transmission layer by using the modulo boundary. The specific process of the modulo operation is explained and illustrated in detail in the above FIGS. 2 (a)-(d), and is not repeated herein.

Optionally, the precoding method according to the embodiment of the present disclosure may further include: transmitting information about the determined modulo boundary to a receiving end of the receiving device. Specifically, the information about the determined modulo boundary may be transmitted to the receiving end in an explicit or implicit manner. In one example, the information about the determined modulo boundary may be notified to the receiving end through, for example, DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is notified with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 below (where α₁˜α₃ are positive real numbers):

TABLE 1

| Constellation diagram Boundary | |
|---|---|
| Indication Field | Meaning |
| 00 | No modulo operation (a = ∞) |
| 01 | α = α₁ |
| 10 | α = α₂ |
| 11 | α = α₃ |

In another example, the information about the determined modulo boundary may be represented by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is infinite; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above notification manner of the information about the modulo boundary is merely an example. In practical applications, any manner of notifying the modulo boundary may be adopted, which is not restricted herein.

Specifically, for the mapping scheme of the serial number of the DMRS port, one implementation is to add to the standard the following predefined mapping tables (Table 2 and Table 3) between the port and the constellation diagram modulo boundary:

TABLE 2

| Serial number of DMRS port | Constellation diagram modulo boundary |
|---|---|
| 1000~1011 | No modulo operation (α = ∞) |

TABLE 3

| Serial number of DMRS port | Constellation diagram modulo boundary |
|---|---|
| 1000~1001 | No modulo operation (α = ∞) |
| 1002~1003 | α = α₁ |
| 1003~1005 | α = α₂ |
| 1006 and above | α = α₃ |

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above manner for the DCI signaling configuration and the DMRS port mapping configuration are merely examples. In practical applications, any configuration and mapping manner of the modulo boundary may be adopted, which is not restricted herein.

In the above examples, a specific implementation manner of determining the modulo boundary according to a transmission layer identifier according to the embodiment of the present disclosure is described. In another embodiment of the present disclosure, different data symbols to be transmitted may also be grouped, so that the modulo operation is performed on each group of data symbols to be transmitted with a common modulo vector to further improve the transmission quality. For example, the method may further include: grouping the data symbols to be transmitted; selecting a common modulo vector for each group of data symbols to be transmitted; processing each group of data symbols to be transmitted according to the selected common modulo vector to acquire transmission symbols. Specifically, the grouping the data symbols to be transmitted may include: grouping the data symbols to be transmitted which are transmitted on adjacent transmission layers/data streams into one group; grouping the data symbols to be transmitted which are transmitted on adjacent subcarriers into one group; or grouping the data symbols to be transmitted which are transmitted on adjacent time-domain symbols into one group. For example, every two of a plurality of data symbols to be transmitted which need to be transmitted may be grouped into one group, and the modulo processing is performed on the two data symbols to be transmitted with a common modulo vector to obtain the transmission symbols. Optionally, the two data symbols to be transmitted in each group may be data symbols to be transmitted that are transmitted on adjacent transmission layers.

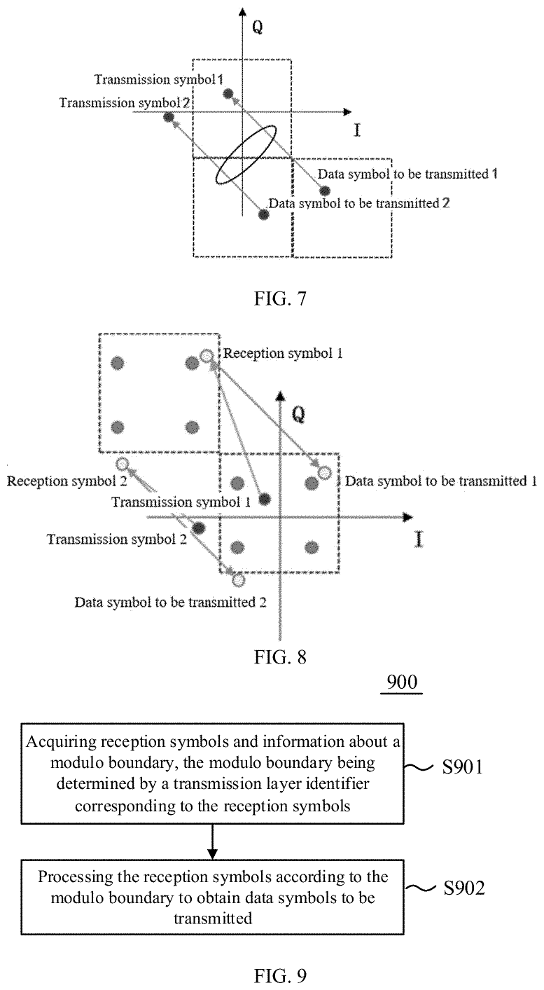

FIG. 7 shows a method for precoding one group of data symbols to be transmitted which is composed of two data symbols to be transmitted by selecting the common modulo vector according to one embodiment of the present disclosure. As shown in FIG. 7, the transmitting device performs the modulo operation on the two data symbols to be transmitted by using the common modulo vector (indicated by an arrow) to obtain two transmission symbols after the modulo operation. FIG. 8 shows a method for performing the modulo operation on two reception symbols in one group by using the common modulo vector to decode the two reception symbols according to one embodiment of the present disclosure. As shown in FIG. 8, at the receiving end of the receiving device, the common modulo vector is calculated, and the modulo operation is performed on the two reception symbols composed of the transmission symbol and the interference vector together by using the calculated common modulo vector, to acquire the data symbols to be transmitted that the transmitting device wishes to transmit.

Correspondingly, after the transmitting device determines a grouping condition of the data symbols to be transmitted, information about the grouping conditions of the data symbols to be transmitted may be notified to the receiving end of the receiving device. For example, the transmitting device may transmit information about the number of symbols contained in each group of data symbols to be transmitted. Specifically, the transmitting device may transmit the information about the number of symbols contained in each group of data symbols to be transmitted in an explicit or implicit manner. For example, the information that each group of data symbols to be transmitted includes for example 2 or 4 data symbols to be transmitted may be transmitted through the DCI dynamic signaling. In addition, the transmitting device may also notify the receiving device of other information about the grouping in an explicit or implicit manner. In one example, information about the grouping standard of the data symbols to be transmitted may be transmitted. For example, it may be notified through the DCI dynamic signaling to receiving end that the grouping standard of the data symbols to be transmitted is to group the data symbols to be transmitted which are transmitted on adjacent subcarriers into one group.

In one implementation, a parameter indicating grouping information may be added to the higher layer signaling, such as the RRC configuration signaling, and notified to the receiving device, and the parameter is used to indicate whether to perform symbol grouping. The parameter may be, for example, a reModuloBindingEnable field. For example, when the parameter has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the parameter has a value of 0, the foregoing grouping is not enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the linear/non-linear precoding configuration or indication is non-linear precoding; and the grouping may not be enabled when the linear/non-linear precoding configuration or indication is linear precoding.

In another example, parameters such as the grouping size on the frequency domain subcarrier, the time domain symbol, and the spatial domain layer may also be independently configured. For example, when a corresponding configuration of a domain is 1, the grouping may not be enabled in the corresponding domain. Specifically, for example, parameters (such as reModuloBindingSubcarrierSize, reModuloBindingSymbol Size, reModuloBindingLayerSize) may be added to the RRC configuration signaling and notified to the receiving device.

When selecting the common modulo vector for each group of data symbols to be transmitted, a modulo vector that minimizes the average power of the transmission symbols may be selected as the common modulo vector, wherein the transmission symbols are acquired after the modulo operation is performed on one group of data symbols to be transmitted. For example, pₖ and qₖ may be respectively expressed as:

$${p}_{k} = [ - \frac{{\sum }_{m = 1}^{M} Re \{ {x}_{k , m} \}}{\sqrt{α} M} ]$$

$${q}_{k} = [ - \frac{{\sum }_{m = 1}^{M} Im \{ {x}_{k , m} \}}{\sqrt{α} M} ]$$

where M is the number of data symbols to be transmitted in one group, x_{k,m} is the m-th data symbol to be transmitted in one group of the k-th user, [x] is a rounding operation which may be a up rounding, a down rounding, or a rounding by minimum distance. Therefore, when the modulo vector that minimizes the average power of the transmission symbols is selected as the common modulo vector, wherein the transmission symbols are acquired after the modulo operation is performed on one group of data symbols to be transmitted, the above result may be calculated so that the following condition is satisfied:

$$min {\sum }_{m = 1}^{M} \vert \vert {x}_{k , m} + \sqrt{α} ( {p}_{k} + {jq}_{k} ) {\vert \vert}^{2}$$

where pₖ and qₖ are integers.

In addition, when the common modulo vector is selected for each group of data symbols to be transmitted, a modulo vector that minimizes the maximum power in the transmission symbols may be selected as the common modulo vector, wherein the transmission symbols are acquired after the modulo operation is performed on one group of transmission symbols. For example, at this time, pₖ and qₖ may be respectively expressed as:

$${p}_{k} = [ - \frac{max \{ Re \{ {x}_{k , m} \} {\vert}_{m} \} + min \{ Re \{ {x}_{k , m} \} {\vert}_{m} \}}{2 \sqrt{α}} ]$$

$${q}_{k} = [ - \frac{max \{ Im \{ {x}_{k , m} \} {\vert}_{m} \} + min \{ Im \{ {x}_{k , m} \} {\vert}_{m} \}}{2 \sqrt{α}} ]$$

Therefore, when the modulo vector that minimizes the maximum power in the transmission symbols is selected as the common modulo vector, wherein the transmission symbols are acquired after the modulo operation is performed on one group of data symbols to be transmitted, the above result may be calculated so that the following condition is satisfied:

min∥Re{x_{k,m}+\sqrt{α}(pₖ+jqₖ)},Im{x_{k,m}+\sqrt{α}(pₖ+jqₖ)}∥_{∞}

Where pₖ and qₖ are integers, and ∥x₁, . . . , x_{M} ∥_{∞} represents the infinite norm.

It can be seen that, by using the precoding method according to the embodiment of the present disclosure, it is possible to determine the modulo boundary in the modulo operation according to the transmission layer identifier for signal transmission during the precoding process, and the transmission signal is processed according to the determined modulo boundary, so that the receiving device performs the corresponding signal receiving and decoding operations. The method in the present disclosure can further reduce losses such as themodulo loss and the power loss brought by the modulo operation to the communication system, and effectively improve the performance of the communication system.

Hereinafter, a decoding method performed by a receiving device according to an embodiment of the present disclosure is described with reference to FIG. 9. FIG. 9 shows a flowchart of the decoding method 900. The decoding method in the embodiment of the present disclosure may be applied to non-linear precoding (such as THP precoding, VP precoding, etc.). Furthermore, the receiving device in the embodiment of the present disclosure may be any communication device, for example, a base station or a user equipment UE, which is not restricted herein.

As shown in FIG. 9, in step S901, reception symbols and information about a modulo boundary are acquired, where the modulo boundary is determined by a transmission layer identifier corresponding to the reception symbols.

In this step, the receiving device may first acquire the reception symbol rₖ and the information about the modulo boundary, for subsequent modulo boundary judgment and specific modulo operation or the like. In one example, information about the determined modulo boundary may be acquired in an explicit or implicit manner. In one example, the information about the modulo boundary may be acquired, for example, through DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is acquired with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 (where α₁˜α₃ are positive real numbers).

In another example, the information about the determined modulo boundary may be acquired by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is ∞; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above acquiring manner of the information about the modulo boundary is merely an example. In practical applications, any manner of acquiring the modulo boundary may be adopted, which is not restricted herein.

Specifically, for the mapping scheme of the serial number of the DMRS port, one implementation is to add to the standard the following predefined mapping tables (such as Table 2 and Table 3) between the port and the constellation diagram modulo boundary.

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above manner for the DCI signaling configuration and the DMRS port mapping configuration are merely examples. In practical applications, any configuration and mapping manner of the modulo boundary may be adopted, which is not restricted herein.

In step S902, the reception symbols may be processed according to the modulo boundary to acquire the data symbols to be transmitted. Specifically, when the modulo boundary is determined to be infinity, the modulo operation may not be performed on the reception symbols; and when the modulo boundary is not infinity, the modulo operation may be performed on the reception symbols according to the determined modulo boundary to acquire the data symbol aₖ to be transmitted. The specific process of the modulo operation is explained and illustrated in detail in the foregoing FIGS. 3 (a)-(b), and is not repeated herein.

Optionally, the decoding method according to the embodiment of the present disclosure may further include: acquiring the reception symbols and the information about reception symbol grouping; processing, according to the information about the reception symbol grouping, each group of reception symbols by using a common modulo vector of each group of reception symbols, to acquire the data symbols to be transmitted. Specifically, after determining a grouping condition of the reception symbols, each group of reception symbols may be processed by using the common modulo vector of each group of reception symbols according to the information of the grouping for the reception symbols to obtain the data symbols to be transmitted.

In one implementation, the transmitting device may add a parameter indicating grouping information to a higher layer signaling, such as an RRC configuration signaling, and notify the receiving device, and the parameter is used to indicate whether to perform symbol grouping. The parameter may be, for example, a reModuloBindingEnable field. For example, when the parameter received by the receiving device has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the received parameter has a value of 0, the foregoing grouping may not be enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the received linear/non-linear precoding configuration or indication is non-linear precoding; and the grouping is not enabled when the received linear/non-linear precoding configuration or indication is linear precoding.

In another example, parameters such as the grouping size on the frequency domain subcarrier, the time domain symbol, and the spatial domain layer may also be independently configured. For example, when a received corresponding configuration of a domain is 1, the grouping may not be enabled in the corresponding domain. Specifically, for example, parameters (such as reModuloBindingSubcarrierSize, reModuloBindingSymbolSize, reModuloBindingLayerSize) may be added to the RRC configuration signaling and notified to the receiving device.

When the reception signal is detected by using the common modulo vector of each group of reception symbol, in one example, pₖ and qₖ in the modulo vector may be used as unknown parameters, while the reception symbols may be used as uniformly distributed random variables, to first detect pₖ and qₖ, followed by a symbol detection by using a commonly used MIMO detector. For detection of pₖ and qₖ, a maximum likelihood detection may be performed by employing a likelihood function shown in the following formula.

$$log p ( y \vert {p}_{k} , {q}_{k} ) = {\sum }_{m = 1}^{M} log ( {\sum }_{n = 1}^{{N}_{c}} exp ( - \frac{{‖ {y}_{k , m} - {\overline{h}}_{k , m} ( {c}_{n} + \sqrt{α} ( {p}_{k} + j {q}_{k} ) ) ‖}^{2}}{{σ}^{2}} ) )$$

where N_{c} is the number of constellation points in the modulation constellation diagram, y_{k,m} is the reception signal of the m-th data symbol in one group corresponding to the k-th user, and h̅_{k,m} is an equivalent reception channel measured by a user corresponding to the symbol, and cₙ is the constellation point.

It can be seen that, by using the decoding method according to the embodiment of the present disclosure, it is possible to determine the modulo boundary in the modulo operation according to the transmission layer identifier for signal transmission, and to perform the corresponding signal receiving and decoding operations according to the determined modulo boundary. The method in the present disclosure can further reduce losses such as the modulo loss and the power loss brought by the modulo operation to the communication system, and effectively improve the performance of the communication system.

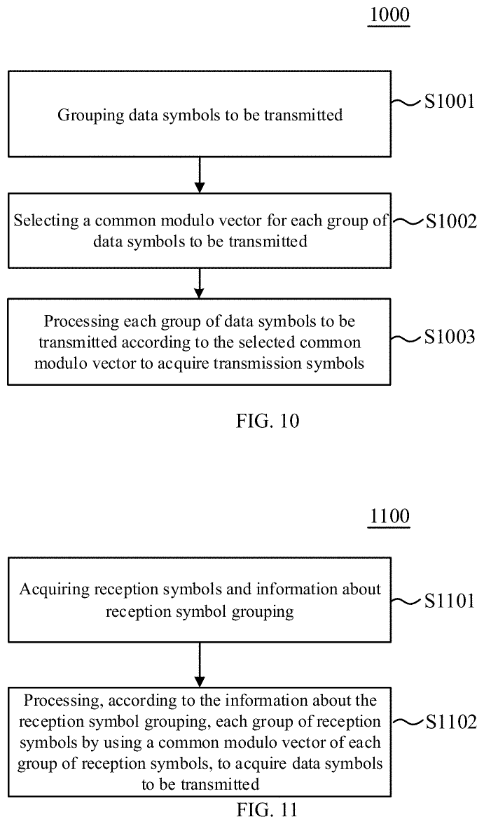

Hereinafter, a precoding method performed by a transmitting device according to an embodiment of the present disclosure is described with reference to FIG. 10. FIG. 10 shows a flowchart of the precoding method 1000. The precoding method in the embodiment of the present disclosure may be applied to non-linear precoding (such as THP precoding, VP precoding). Furthermore, the receiving device in the embodiment of the present disclosure may be any communication device, for example, a base station or user equipment. UE, which is not restricted herein.

As shown in FIG. 10, in step S1001, data symbols to be transmitted are grouped.

Specifically, the grouping the data symbols to be transmitted may include: grouping the data symbols to be transmitted which are transmitted on adjacent transmission layers/data streams into one group; grouping the data symbols to be transmitted which are transmitted on adjacent subcarriers into one group; or grouping the data symbols to be transmitted which are transmitted on adjacent time-domain symbols into one group. For example, in one example, every two of a plurality of data symbols to be transmitted which need to be transmitted may be grouped into one group, and the modulo processing is performed on the two data symbols to be transmitted with a common modulo vector to obtain the transmission symbols. Optionally, the two data symbols to be transmitted in each group may be data symbols to be transmitted that are transmitted on adjacent transmission layers.

Accordingly, after the transmitting device determines a grouping condition of the data symbols to be transmitted, information about the grouping conditions of the data symbols to be transmitted may be notified to a receiving end of a receiving device. For example, the transmitting device may transmit information about the number of symbols contained in each group of data symbols to be transmitted. Specifically, the transmitting device may transmit the information about the number of symbols contained in each group of data symbols to be transmitted in an explicit or implicit manner. For example, the information that each group of data symbols to be transmitted includes 2 or 4 data symbols to be transmitted may be transmitted through a DCI dynamic signaling. In addition, the transmitting device may also notify the receiving device of other information about the grouping in an explicit or implicit manner. In one example, information about the grouping standard of the data symbols to be transmitted may be transmitted. For example, it may be notified through the DCI dynamic signaling to the receiving end that the grouping standard of the data symbols to be transmitted is to group the data symbols to be transmitted on adjacent subcarriers into one group.

In one implementation, a parameter indicating grouping information may be added to a higher layer signaling, such as an RRC configuration signaling, and notified to the receiving device, and the parameter is used to indicate whether to perform symbol grouping. The parameter may be, for example, a reModuloBindingEnable field. For example, when the parameter has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the parameter has a value of 0, the foregoing grouping is not enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the linear/non-linear precoding configuration or indication is non-linear precoding; and the grouping may not be enabled when the linear/non-linear precoding configuration or indication is linear precoding.

In another example, parameters such as the grouping size on the frequency domain subcarrier, the time domain symbol, and the spatial domain layer may also be independently configured. For example, when a corresponding configuration of a domain is 1, the grouping may not be enabled in the corresponding domain. Specifically, for example, parameters (such as reModuloBindingSubcarrierSize, reModuloBindingSymbol Size, reModuloBindingLayerSize) may be added to the RRC configuration signaling and notified to the receiving device.

In step S1002, a common modulo vector is selected for each group of data symbols to be transmitted. In one example, a modulo vector that minimizes the average power of the transmission symbols may be selected as the common modulo vector, wherein the transmission symbols are acquired after the modulo operation is performed on one group of data symbols to be transmitted. For example, pₖ and qₖ may be respectively expressed as:

$${P}_{k} = [ - \frac{{\sum }_{m = 1}^{M} Re \{ {x}_{k , m} \}}{\sqrt{α} M} ] \\ {q}_{k} = [ - \frac{{\sum }_{m = 1}^{M} Im \{ {x}_{k , m} \}}{\sqrt{α} M} ]$$

where M is the number of data symbols to be transmitted in one group, x_{k,m} is the m-th data symbol to be transmitted in one group of the k-th user, [x] is a rounding operation which may be a up rounding, a down rounding, or a rounding by minimum distance. Therefore, when the modulo vector that minimizes the average power of the transmission symbols is selected as the common modulo vector, wherein the transmission symbols are acquired after the modulo operation is performed on one group of data symbols to be transmitted, the above result may be calculated so that the following condition is satisfied:

$$min {\sum }_{m = 1}^{M} {‖ {x}_{k , m} + \sqrt{α} ( {p}_{k} + j {q}_{k} ) ‖}^{2}$$

where pₖ and qₖ are integers.

In addition, in another example, when the common modulo vector is selected for each group of data symbols to be transmitted, a modulo vector that minimizes the maximum power in the transmission symbols may be selected as the common modulo vector, wherein the transmission symbols are acquired after the modulo operation is performed on one group of transmission symbols. For example, at this time, pₖ and qₖ may be respectively expressed as:

$${P}_{k} = [ - \frac{max \{ Re \{ {x}_{k , m} \} {\vert}_{m} \} + min {\{ Re \{ {x}_{k , m} \} \vert}_{m} \}}{2 \sqrt{α}} ] \\ {q}_{k} = [ - \frac{max \{ Im \{ {x}_{k , m} \} {\vert}_{m} \} + min {\{ Im \{ {x}_{k , m} \} \vert}_{m} \}}{2 \sqrt{α}} ]$$

Therefore, when the modulo vector that minimizes the maximum power in the transmission symbols is selected as the common modulo vector, wherein the transmission symbols are acquired after the modulo operation is performed on one group of data symbols to be transmitted, the above result may be calculated so that the following condition is satisfied:

min∥Re{x_{k,m}+\sqrt{α}(pₖ+jqₖ)},Im{x_{k,m}+\sqrt{α}(pₖ+jqₖ)}∥_{∞}

Where pₖ and qₖ are integers, and ∥x₁, . . . , x_{M}∥_{∞} represents the infinite norm.

In step S1003, each group of data symbols to be transmitted may be processed according to the selected common modulo vector to acquire the transmission symbols.

FIG. 7 shows a method for precoding one group of data symbols to be transmitted by selecting the common modulo vector according to one embodiment of the present disclosure, where the group of data symbols is composed of two data symbols to be transmitted. As shown in FIG. 7, the transmitting device performs the modulo operation on the two data symbols to be transmitted by using the common modulo vector (indicated by an arrow) to obtain two transmission symbols after the modulo operation. FIG. 8 shows a method for performing the modulo operation on two reception symbols in one group by using the common modulo vector to decode the two reception symbols according to one embodiment of the present disclosure. As shown in FIG. 8, at the receiving end of the receiving device, the common modulo vector is calculated, and the modulo operation is performed on the two reception symbols composed of the transmission symbol and the interference vector together by using the calculated common modulo vector, to acquire the data symbols to be transmitted that the transmitting device wishes to transmit.

In another implementation of the embodiment of the present disclosure, the method may further include: determining a modulo boundary for a precoding modulo operation according to a transmission layer identifier corresponding to each group of data symbols to be transmitted; and the processing each group of data symbols to be transmitted according to the common modulo vector may further include: processing each group of data symbols to be transmitted according to the selected common modulo vector and the modulo boundary. Specifically, in the same group of data symbols to be transmitted, the determined modulo boundaries are the same; while in different groups of data symbols to be transmitted, the determined modulo boundaries may be different. For example, when the corresponding transmission layer identifier in the group of data symbols to be transmitted increases, the modulo boundary may be gradually reduced. Optionally, when the corresponding one or more transmission layer identifiers in one group of data symbol groups to be transmitted are less than or equal to a preset transmission layer identifier, the modulo boundary determined for the group of data symbols to be transmitted may be considered to be infinite, therefore the modulo operation may not be performed on the data symbols to be transmitted in the group of data symbols to be transmitted. The above method for determining the modulo boundary for the group of data symbols to be transmitted is merely an example. In practical applications, any method for determining the modulo boundary may be adopted, which is not restricted herein. FIG. 6 shows an example of determining the modulo boundary for the group of data symbols to be transmitted according to another embodiment of the present disclosure. As shown in FIG. 6, when the corresponding transmission layer identifier in the group of data symbols to be transmitted is 1-3, the modulo boundary α may be ∞, so that the modulo operation is not performed on the data symbols to be transmitted in the group of data symbols to be transmitted; when the corresponding transmission layer identifier in the group of data symbols to be transmitted is 4-6, the modulo boundary α may be 4; when the transmission layer identifier in the group of data symbols to be transmitted is greater than or equal to 7, the modulo boundary α may be 2.

After determining the modulo boundary, the data symbols to be transmitted may be processed according to the determined modulo boundary and the common modulo vector. The specific process of the modulo operation is explained and illustrated in detail in the above FIGS. 2 (a)-(d), and is not repeated herein.

Optionally, the precoding method according to the embodiment of the present disclosure may further include: transmitting information about the determined modulo boundary to a receiving end of the receiving device. Specifically, the information about the determined modulo boundary may be transmitted to the receiving end in an explicit or implicit manner. In one example, the information about the determined modulo boundary may be notified to the receiving end through, for example, DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is notified with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 (where α₁˜α₃ are positive real numbers).

In another example, the information about the determined modulo boundary may be represented by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is ∞; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above notification manner of the information about the modulo boundary is merely an example. In practical applications, any manner of notifying the modulo boundary may be adopted, which is not restricted herein.

Specifically, for the mapping scheme of the serial number of the DMRS port, one implementation is to add to the standard the following predefined mapping tables (such as Table 2 and Table 3) between the port and the constellation diagram modulo boundary.

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above manner for the DCI signaling configuration and the DMRS port mapping configuration are merely examples. In practical applications, any configuration and mapping manner of the modulo boundary may be adopted, which is not restricted herein.

It can be seen that, by using the precoding method according to the embodiment of the present disclosure, it is possible to group the data symbols to be transmitted during the precoding process and determine the common modulo vector for processing according to the grouping. This grouping and processing manner on the data symbols to be transmitted may combine a plurality of symbols to perform joint precoding and decoding processing, thereby avoiding the problems of high error rate and low performance caused by independent decoding, improving the decoding accuracy and decoding efficiency, and enhancing the reliability of the system.

Hereinafter, a decoding method performed by a receiving device according to an embodiment of the present disclosure is described with reference to FIG. 11. FIG. 11 shows a flowchart of the decoding method 1100. The decoding method in the embodiment of the present disclosure may be applied to non-linear precoding (such as THP precoding, VP precoding). Furthermore, the receiving device in the embodiment of the present disclosure may be any communication device, for example, a base station or user equipment UE, which is not restricted herein.

As shown in FIG. 11, in step S1101, reception symbols and information about reception symbol grouping are acquired.

Specifically, the receiving device may receive the information about the reception symbol grouping. For example, the receiving device may receive the information about the number of symbols contained in each group of reception symbols in an explicit or implicit manner. For example, the information that each group of data symbols to be transmitted includes 2 or 4 data symbols to be transmitted may be received through a DCI dynamic signaling. In addition, the receiving device may also receive other information about the grouping in an explicit or implicit manner. In one example, information about the grouping standard of the data symbols to be transmitted may be received. For example, it may be learned through the DCI dynamic signaling to the receiving end that the grouping standard of the data symbols to be transmitted is to group the data symbols to be transmitted on adjacent subcarriers into one group.

In one implementation, the transmitting device may add a parameter indicating grouping information may to a higher layer signaling, such as an RRC configuration signaling, and notified to the receiving device, and the parameter is used to indicate whether to perform symbol grouping. The parameter may be, for example, a reModuloBindingEnable field. For example, when the parameter received by the receiving device has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the received parameter has a value of 0, the foregoing grouping may not be enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the received linear/non-linear precoding configuration or indication is non-linear precoding; and the grouping is not enabled when the received linear/non-linear precoding configuration or indication is linear precoding.

In another example, parameters such as the grouping size on the frequency domain subcarrier, the time domain symbol, and the spatial domain layer may also be independently configured. For example, when a received corresponding configuration of a domain is 1, the grouping may not be enabled in the corresponding domain. Specifically, for example, parameters (such as reModuloBindingSubcarrierSize, reModuloBindingSymbolSize, reModuloBindingLayerSize) may be added to the RRC configuration signaling and notified to the receiving device.

In step S1102, each group of reception symbols is processed by using a common modulo vector for each group of reception symbols according to the information of the reception symbol grouping to acquire the data symbols to be transmitted.

When the reception signal is detected by using the common modulo vector of each group of reception symbol, in one example, pₖ and qₖ in the modulo vector may be used as unknown parameters, while the reception symbols may be used as uniformly distributed random variables, to first detect pₖ and qₖ, followed by a symbol detection by using a commonly used MIMO detector. For detection of pₖ and qₖ, a maximum likelihood detection may be performed by employing a likelihood function shown in the following formula.

$$log p ( y \vert {p}_{k} , {q}_{k} ) = {\sum }_{m = 1}^{M} log ( {\sum }_{n = 1}^{{N}_{c}} exp ( - \frac{{‖ {y}_{k , m} - {\overline{h}}_{k , m} ( {c}_{n} + \sqrt{α} ( {p}_{k} + j {q}_{k} ) ) ‖}^{2}}{{σ}^{2}} ) )$$

where N_{c} is the number of constellation points in the modulation constellation diagram, y_{k,m} is the reception signal of the m-th data symbol in one group corresponding to the k-th user, and h̅_{k,m} is an equivalent reception channel measured by a user corresponding to the symbol, and cₙ is the constellation point.

In one implementation of the present disclosure, the method may further include: acquiring information about a modulo boundary, the modulo boundary being determined by a transmission layer identifier corresponding to each group of reception symbols; and the processing each group of reception symbols by using the common modulo vector of each group of reception symbols may further include: processing each group of data symbols to be transmitted according to the common modulo vector and the modulo boundary. Specifically, the receiving device may acquire the information about the modulo boundary. In one example, the information about the determined modulo boundary may be acquired in an explicit or implicit manner. In one example, the information about the modulo boundary may be acquired, for example, through DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is acquired with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 (where α₁˜α₃ are positive real numbers).

In another example, the information about the determined modulo boundary may be acquired by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is ∞; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above acquiring manner of the information about the modulo boundary is merely an example. In practical applications, any manner of acquiring the modulo boundary may be adopted, which is not restricted herein.

Specifically, for the mapping scheme of the serial number of the DMRS port, one implementation is to add to the standard the following predefined mapping tables (such as Table 2 and Table 3) between the port and the constellation diagram modulo boundary.

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above manner for the DCI signaling configuration and the DMRS port mapping configuration are merely examples. In practical applications, any configuration and mapping manner of the modulo boundary may be adopted, which is not restricted herein.

Further, the receiving device may process the reception symbols according to the modulo boundary in combination with the common modulo vector of each group of reception symbols to acquire the data symbols to be transmitted. Specifically, when the modulo boundary is determined to be ∞, the modulo operation may not be performed on the group of reception symbols; and when the modulo boundary is not ∞, the modulo operation may be performed on the group of reception symbols according to the determined modulo boundary to acquire the data symbol aₖ to be transmitted. The specific process of the modulo operation is explained and illustrated in detail in the foregoing FIGS. 3 (a)-(b), and is not repeated herein.

It can be seen that, by using the decoding method according to the embodiment of the present disclosure, it is possible to group the reception symbols during the decoding process and determine the common modulo vector for processing according to the grouping. This grouping and processing manner on the reception symbols may combine a plurality of symbols to perform joint decoding processing, thereby avoiding the problems of high error rate and low performance caused by independent decoding, improving the decoding accuracy and decoding efficiency, and enhancing the reliability of the system.

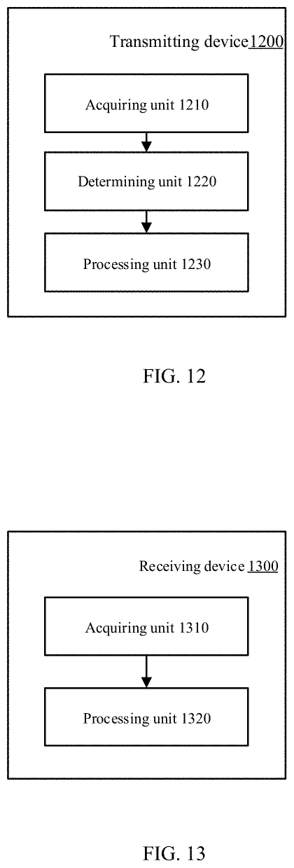

Hereinafter, a transmitting device according to an embodiment of the present application is described with reference to FIG. 12. The transmitting device may perform the above precoding method. Since operations of the transmitting device are basically the same as the respective steps of the precoding method described above, it is only briefly described herein, and repeated description of the same content is omitted.

As shown in FIG. 12, the transmitting device 1200 includes an acquiring unit 1210, a determining unit 1220, and a processing unit 1230. It should be recognized that FIG. 12 only shows components related to the embodiment of the present application, and other components are omitted, but this is only schematic, and the transmitting device 1200 may include other components as needed.

The acquiring unit 1210 acquires data symbols to be transmitted and a transmission layer identifier corresponding to the data symbols to be transmitted.

The acquiring unit 1210 may first acquire a data symbol aₖ to be transmitted and a transmission layer identifier corresponding to the data symbol to be transmitted, for subsequent modulo boundary judgment and specific modulo operation.

The determining unit 1220 determines a modulo boundary for the precoding modulo operation according to the transmission layer identifier corresponding to the data symbols to be transmitted.

Considering that the foregoing different transmission layers have different influences on a power of a transmitted signal, the determining unit 1220 may adaptively determine different modulo boundaries for signals transmitted on different transmission layers with different transmission layer identifiers. In one example, different modulo boundaries may be determined for each different transmission layer identifier. Optionally, when the transmission layer identifier increases, the determined modulo boundary may be gradually reduced. Furthermore, optionally, when the transmission layer identifier is less than or equal to the preset transmission layer identifier, the determined modulo boundary may be considered to be infinite (∞), and therefore, the modulo operation is not performed on the data symbols to be transmitted. In another example, when the data transmitted by the transmitting device to the receiving device is transmitted through a plurality of transmission layers, the plurality of transmission layers may include one or more transmission layer groups, and accordingly, the modulo boundaries may be determined according to the transmission layer groups. Optionally, the determined modulo boundaries for the transmission layer identifiers in the same transmission layer group may be the same; and the determined modulo boundaries may be different in different transmission layer groups. For example, when the transmission layer identifier in the transmission layer group increases, the modulo boundary may be gradually reduced. Considering that the transmission layer group may have a plurality of transmission layer identifiers, therefore, an increase in the transmission layer identifier may be, for example, a maximum transmission layer identifier in one transmission layer group being increased compared with a maximum transmission layer identifier in another transmission layer group, an average transmission layer identifier in one transmission layer group being increased compared with an average transmission layer identifier in another transmission layer group, and one or more transmission layer identifiers in one transmission layer group being increased compared with one or more transmission layer identifiers in another transmission layer group. Optionally, when one or more transmission layer identifiers in the transmission layer group are less than or equal to the preset transmission layer identifier, the modulo boundary determined for the transmission layer group may be considered to be infinite, so that the modulo operation may not be performed on the data symbols to be transmitted corresponding to the transmission layer symbols in the transmission layer group. The above manners of determining the modulo boundary for the transmission layer identifier are only examples. In practical applications, any manner of determining the modulo boundary according to the transmission layer identifier or any grouping manner may be used, which is not restricted herein.

In one implementation, a specific manner to determine the modulo boundaries by the determining unit 1220 for different transmission layer identifiers may be, for example: in the case where the preset transmission layer identifier is set to 1, when the transmission layer identifier is 1, the power σ of an initial signal on which no modulo operation is performed satisfies σ₁²=1, and accordingly the modulo boundary is ∞, and the power after the modulo operation is P₁=1. When the transmission layer identifier is not 1, the power of the initial signal on which no modulo operation is performed should satisfy

$${σ}_{k}^{2} = {\sum }_{l = 1}^{k - 1} {\vert {b}_{k , l} \vert}^{2} {p}_{l} + 1$$

after considering the influence of the interference vectors, and at this time, a relationship between the power Pₖ and the modulo boundary α may be expressed as:

$${P}_{k} = {σ}_{k}^{2} + {\sum }_{m = - ∞}^{+ ∞} \{ 4 {α}^{2} {m}^{2} [ erf ( \frac{α ( 2 m + 1 )}{{σ}_{k}} ) - erf ( \frac{α ( 2 m - 1 )}{{σ}_{k}} ) ] + \frac{4 {σ}_{k} α m}{\sqrt{π}} [ exp ( - \frac{{{α}^{2} ( 2 m + 1 )}^{2}}{{σ}_{k}^{2}} ) - exp ( - \frac{{{α}^{2} ( 2 m - 1 )}^{2}}{{σ}_{k}^{2}} ) ] \}$$

It can be seen that according to the above relationship between Pₖ and α, in the embodiment of the present disclosure, the determining unit 1220 may select an α value that makes Pₖ as small as possible as the modulo boundary. For example, an α value that satisfies Pₖ to be less than a specific power threshold γ may be selected as the modulo boundary. When the α value of the modulo boundary has several possible values, the possible value of a that minimizes Pₖ may be selected as the modulo boundary. The above relationship between Pₖ and a and the selection manner of the α value of the modulo boundary are merely examples. In practical applications, any manner of value selection for the modulo boundary may be adopted.

FIG. 6 shows an example of grouping the transmission layer identifiers and determining a modulo boundary according to another implementation of the present disclosure. According to FIG. 6, when the transmission layer identifier in the transmission layer group is 1-3, the modulo boundary α may be ∞, so that the modulo operation may not be performed on the data symbols to be transmitted corresponding to the transmission layer identifier in the transmission layer group; when the transmission layer identifier in the transmission layer group is 4-6, the modulo boundary α may be 4, which has a larger modulo boundary than a higher transmission layer identifier; when the transmission layer identifier in the transmission layer group is greater than or equal to 7, the modulo boundary α may be 2, which has a relatively smaller modulo boundary.

The processing unit 1230 processes the data symbols to be transmitted according to the determined modulo boundary to acquire transmission symbols.

After the modulo boundary is determined according to the transmission layer identifier, the processing unit 1230 may process the data symbols to be transmitted according to the determined modulo boundary. For example, when the modulo boundary is determined to be co, the modulo operation may not be performed on the data symbols to be transmitted; and when the modulo boundary is not co, the modulo operation may be performed on the data symbols to be transmitted according to the determined modulo boundary, and a transmission symbol X′ₖ that can be transmitted on a transmission layer having this transmission layer identifier is obtained after a subsequent series of processing. The specific process of the modulo operation is explained and illustrated in detail in the above FIGS. 2 (a)-(d), and is not repeated herein.

Optionally, the transmitting device according to the embodiment of the present disclosure may further include a transmitting unit (not shown) configured to transmit the information about the determined modulo boundary to the receiving end of the receiving device. Specifically, the information about the determined modulo boundary may be transmitted to the receiving end in an explicit or implicit manner. In one example, the information about the determined modulo boundary may be notified to the receiving end through, for example, DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is notified with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 (where α₁˜α₃ are positive real numbers).

In another example, the information about the determined modulo boundary may be represented by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is ∞; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above notification manner of the information about the modulo boundary is merely an example. In practical applications, any manner of notifying the modulo boundary may be adopted, which is not restricted herein.

Specifically, for the mapping scheme of the serial number of the DMRS port, one implementation is to add to the standard the following predefined mapping tables (such as Table 2 and Table 3) between the port and the constellation diagram modulo boundary.

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above manner for the DCI signaling configuration and the DMRS port mapping configuration are merely examples. In practical applications, any configuration and mapping manner of the modulo boundary may be adopted, which is not restricted herein.

In another implementation of the present disclosure, the processing unit of the transmitting device may be further configured to perform the following processing: grouping the data symbols to be transmitted; selecting a common modulo vector for each group of data symbols to be transmitted; processing each group of data symbols to be transmitted according to the selected common modulo vector to acquire transmission symbols. Specifically, the processing unit may group the data symbols to be transmitted which are transmitted on adjacent transmission layers/data streams into one group; group the data symbols to be transmitted which are transmitted on adjacent subcarriers into one group; or group the data symbols to be transmitted which are transmitted on adjacent time-domain symbols into one group. For example, in one example, every two of a plurality of data symbols to be transmitted which need to be transmitted may be grouped into one group, and the modulo processing is performed on the two data symbols to be transmitted with a common modulo vector to obtain the transmission symbols. Optionally, the two data symbols to be transmitted in each group may be data symbols to be transmitted that are transmitted on adjacent transmission layers.

Correspondingly, after the transmitting device determines a grouping condition of the data symbols to be transmitted, information about the grouping conditions of the data symbols to be transmitted may be notified to a receiving end of a receiving device. For example, the transmitting device may transmit information about the number of symbols contained in each group of data symbols to be transmitted. Specifically, the transmitting device may transmit the information about the number of symbols contained in each group of data symbols to be transmitted in an explicit or implicit manner. For example, the information that each group of data symbols to be transmitted includes 2 or 4 data symbols to be transmitted may be transmitted through a DCI dynamic signaling. In addition, the transmitting device may also notify the receiving device of other information about the grouping in an explicit or implicit manner. In one example, information about the grouping standard of the data symbols to be transmitted may be transmitted. For example, it may be notified through the DCI dynamic signaling to the receiving end that the grouping standard of the data symbols to be transmitted is to group the data symbols to be transmitted which are transmitted on adjacent subcarriers into one group.

In one implementation, a parameter indicating grouping information may be added to a higher layer signaling, such as an RRC configuration signaling, and notified to the receiving device, and the parameter is used to indicate whether to perform symbol grouping. The parameter may be, for example, a reModuloBindingEnable field. For example, when the parameter has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the parameter has a value of 0, the foregoing grouping is not enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the linear/non-linear precoding configuration or indication is non-linear precoding; and the grouping may not be enabled when the linear/non-linear precoding configuration or indication is linear precoding.

In another example, parameters such as the grouping size on the frequency domain subcarrier, the time domain symbol, and the spatial domain layer may also be independently configured. For example, when a corresponding configuration of a domain is 1, the grouping may not be enabled in the corresponding domain. Specifically, for example, parameters (such as reModuloBindingSubcarrierSize, reModuloBindingSymbol Size, reModuloBindingLayerSize) may be added to the RRC configuration signaling and notified to the receiving device.

When selecting the common modulo vector for each group of data symbols to be transmitted, the processing unit may select a modulo vector that minimizes the average power of the transmission symbols as the common modulo vector, wherein the transmission symbols are acquired after the modulo operation is performed on one group of data symbols to be transmitted. For example, pₖ and qₖ may be respectively expressed as:

$${P}_{k} = [ - \frac{{\sum }_{m = 1}^{M} Re \{ {x}_{k , m} \}}{\sqrt{α} M} ] \\ {q}_{k} = [ - \frac{{\sum }_{m = 1}^{M} Im \{ {x}_{k , m} \}}{\sqrt{α} M} ]$$

Where M is the number of data symbols to be transmitted in one group, x_{k,m} is the m-th data symbol to be transmitted in one group of the k-th user, [x] is a rounding operation which may be a up rounding, a down rounding, or a rounding by minimum distance. Therefore, when the modulo vector that minimizes the average power of the transmission symbols is selected as the common modulo vector, wherein the transmission symbols are acquired after the modulo operation is performed on one group of data symbols to be transmitted, the above result may be calculated so that the following condition is satisfied:

$$min {\sum }_{m = 1}^{M} {‖ {x}_{k , m} + \sqrt{α} ( {p}_{k} + j {q}_{k} ) ‖}^{2}$$

where pₖ and qₖ are integers.

In addition, when selecting the common modulo vector for each group of data symbols to be transmitted, the processing unit may select a modulo vector that minimizes the maximum power in the transmission symbols as the common modulo vector, wherein the transmission symbols are acquired after the modulo operation is performed on one group of transmission symbols. For example, at this time, pₖ and qₖ may be respectively expressed as:

$${P}_{k} = [ - \frac{max \{ Re \{ {x}_{k , m} \} {\vert}_{m} \} + min {\{ Re \{ {x}_{k , m} \} \vert}_{m} \}}{2 \sqrt{α}} ] \\ {q}_{k} = [ - \frac{max \{ Im \{ {x}_{k , m} \} {\vert}_{m} \} + min {\{ Im \{ {x}_{k , m} \} \vert}_{m} \}}{2 \sqrt{α}} ]$$

Therefore, when the modulo vector that minimizes the maximum power in the transmission symbols as the common modulo vector, wherein the transmission symbols are acquired after the modulo operation is performed on one group of data symbols to be transmitted is selected, the above result may be calculated so that the following condition is satisfied:

min∥Re{x_{k,m}+\sqrt{α}(pₖ+jqₖ)},Im{x_{k,m}+\sqrt{α}(pₖ+jqₖ)}∥_{∞}

where pₖ and qₖ are integers, and ∥x₁, . . . , x_{M}∥_{∞} represents the infinite norm.

FIG. 7 shows a method in which the processing unit of the transmitting device precodes one group of data symbols to be transmitted by selecting the common modulo vector according to one embodiment of the present disclosure, where the group of data symbols is composed of two data symbols to be transmitted. As shown in FIG. 7, the transmitting device performs the modulo operation on the two data symbols to be transmitted by using the common modulo vector (indicated by an arrow) to obtain two transmission symbols after the modulo operation. FIG. 8 shows a method in which the receiving device performs the modulo operation on two reception symbols in one group by using the common modulo vector to decode the two reception symbols according to one embodiment of the present disclosure. As shown in FIG. 8, at the receiving end of the receiving device, the common modulo vector is calculated, and the modulo operation is performed on the two reception symbols composed of the transmission symbol and the interference vector together by using the calculated common modulo vector, to acquire the data symbols to be transmitted that the transmitting device wishes to transmit.

It can be seen that, by using the transmitting device according to the embodiment of the present disclosure, it is possible to determine the modulo boundary in the modulo operation according to the transmission layer identifier for signal transmission during the precoding process, and the transmission signal is processed according to the determined modulo boundary, so that the receiving device performs the corresponding signal receiving and decoding operations. The transmitting device in the present disclosure can further reduce losses such as the modulo loss and the power loss brought by the modulo operation to the communication system, and effectively improve the performance of the communication system.

Hereinafter, a receiving device according to an embodiment of the present application is described with reference to FIG. 13. The receiving device may perform the above decoding method. Since operations of the receiving device are basically the same as the respective steps of the decoding method described above, it is only briefly described herein, and repeated description of the same content is omitted.

As shown in FIG. 13, the receiving device 1300 includes an acquiring unit 1310 and a processing unit 1320. It should be recognized that FIG. 13 only shows components related to the embodiment of the present application, and other components are omitted, but this is only schematic, and the receiving device 1300 may include other components as needed.

The acquiring unit 1310 acquires reception symbols and information about a modulo boundary, where the modulo boundary is determined by a transmission layer identifier corresponding to the reception symbols.

The acquiring unit 1310 may first acquire the reception symbol rₖ and the information about the modulo boundary, for subsequent modulo boundary judgment and specific modulo operation or the like. In one example, information about the determined modulo boundary may be acquired in an explicit or implicit manner. In one example, the information about the modulo boundary may be acquired, for example, through DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is acquired with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 (where α₁˜α₃ are positive real numbers).

In another example, the information about the determined modulo boundary may be acquired by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is ∞; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above acquiring manner of the information about the modulo boundary is merely an example. In practical applications, any manner of acquiring the modulo boundary may be adopted, which is not restricted herein.

Specifically, for the mapping scheme of the serial number of the DMRS port, one implementation is to add to the standard the following predefined mapping tables (such as Table 2 and Table 3) between the port and the constellation diagram modulo boundary.

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above-mentioned methods for the DCI signaling configuration and the DMRS port mapping configuration are merely The above manner for the DCI signaling configuration and the DMRS port mapping configuration are merely examples. In practical applications, any configuration and mapping manner of the modulo boundary may be adopted, which is not restricted herein.

The processing unit 1320 may process the reception symbols according to the modulo boundary to acquire the data symbols to be transmitted. Specifically, when the modulo boundary is determined to be ∞, the modulo operation may not be performed on the reception symbols; and when the modulo boundary is not ∞, the modulo operation may be performed on the reception symbols according to the determined modulo boundary to acquire the data symbol aₖ to be transmitted. The specific process of the modulo operation is explained and illustrated in detail in the foregoing FIGS. 3 (a)-(b), and is not repeated herein.

Optionally, the processing unit 1320 of the receiving device according to the embodiment of the present disclosure may further acquire the reception symbols and the information about reception symbol grouping; and process, according to the information about the reception symbol grouping, each group of reception symbols by using a common modulo vector of each group of reception symbols, to acquire the data symbols to be transmitted. After determining a grouping condition of the reception symbols, each group of reception symbols may be processed by using the common modulo vector of each group of reception symbols according to the information of the grouping for the reception symbols to obtain the data symbols to be transmitted.

In one implementation, the transmitting device may add a parameter indicating grouping information to a higher layer signaling, such as an RRC configuration signaling, and notify the receiving device, and the parameter is used to indicate whether to perform symbol grouping. The parameter may be, for example, a reModuloBindingEnable field. For example, when the parameter received by the receiving device has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the received parameter has a value of 0, the foregoing grouping may not be enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the received linear/non-linear precoding configuration or indication is non-linear precoding; and the grouping is not enabled when the received linear/non-linear precoding configuration or indication is linear precoding.

In another example, parameters such as the grouping size on the frequency domain subcarrier, the time domain symbol, and the spatial domain layer may also be independently configured. For example, when a received corresponding configuration of a domain is 1, the grouping may not be enabled in the corresponding domain. Specifically, for example, parameters (such as reModuloBindingSubcarrierSize, reModuloBindingSymbol Size, reModuloBindingLayerSize) may be added to the RRC configuration signaling and notified to the receiving device.

When detecting the reception signal by using the common modulo vector of each group of reception symbol, in one example, the processing unit 1320 may take pₖ and qₖ in the modulo vector as unknown parameters, while the reception symbols may be used as uniformly distributed random variables, to first detect pₖ and qₖ, followed by a symbol detection by using a commonly used MIMO detector. For detection of pₖ and qₖ, a maximum likelihood detection may be performed by employing a likelihood function shown in the following formula.

$$log p ( y \vert {p}_{k} , {q}_{k} ) = {\sum }_{m = 1}^{M} log ( {\sum }_{n = 1}^{{N}_{c}} exp ( - \frac{{‖ {y}_{k , m} - {\overline{h}}_{k , m} ( {c}_{n} + \sqrt{α} ( {p}_{k} + j {q}_{k} ) ) ‖}^{2}}{{σ}^{2}} ) )$$

where N_{c} is the number of constellation points in the modulation constellation diagram, y_{k,m} is the reception signal of the m-th data symbol in one group corresponding to the k-th user, and h̅_{k,m} is an equivalent reception channel measured by a user corresponding to the symbol, and cₙ is the constellation point.

It can be seen that, by using the receiving device according to the embodiment of the present disclosure, it is possible to determine the modulo boundary in the modulo operation according to the transmission layer identifier for signal transmission, and to perform the corresponding signal receiving and decoding operations according to the determined modulo boundary. The receiving device in the present disclosure can further reduce losses such as the modulo loss and the power loss brought by the modulo operation to the communication system, and effectively improve the performance of the communication system.

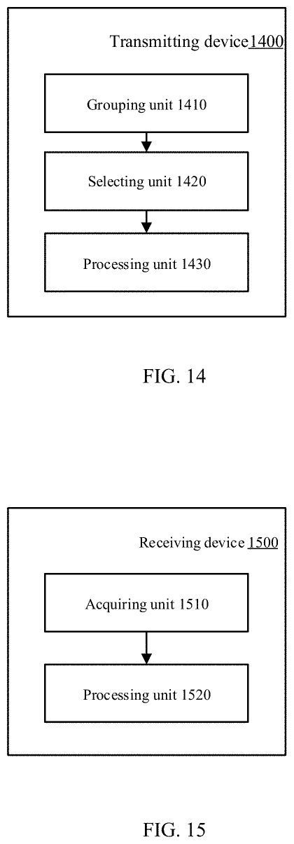

Hereinafter, a transmitting device according to an embodiment of the present application is described with reference to FIG. 14. The transmitting device may perform the above precoding method. Since operations of the transmitting device are basically the same as the respective steps of the precoding method described above, it is only briefly described herein, and repeated description of the same content is omitted.

As shown in FIG. 14, the transmitting device 1400 includes a grouping unit 1410, a selecting unit 1420, and a processing unit 1430. It should be recognized that FIG. 14 only shows components related to the embodiment of the present application, and other components are omitted, but this is only schematic, and the transmitting device 1400 may include other components as needed.

The grouping unit 1410 groups data symbols to be transmitted.

Specifically, the grouping unit 1410 grouping the data symbols to be transmitted may include: grouping the data symbols to be transmitted which are transmitted on adjacent transmission layers/data streams into one group; grouping the data symbols to be transmitted which are transmitted on adjacent subcarriers into one group; or grouping the data symbols to be transmitted which are transmitted on adjacent time-domain symbols into one group. For example, in one example, every two of a plurality of data symbols to be transmitted which need to be transmitted may be grouped into one group, and the modulo processing is performed on the two data symbols to be transmitted with a common modulo vector to obtain the transmission symbols. Optionally, the two data symbols to be transmitted in each group may be data symbols to be transmitted that are transmitted on adjacent transmission layers.

Accordingly, after the transmitting device determines a grouping condition of the data symbols to be transmitted, information about the grouping conditions of the data symbols to be transmitted may be notified to a receiving end of a receiving device. For example, the transmitting device may transmit information about the number of symbols contained in each group of data symbols to be transmitted. Specifically, the transmitting device may transmit the information about the number of symbols contained in each group of data symbols to be transmitted in an explicit or implicit manner. For example, the information that each group of data symbols to be transmitted includes 2 or 4 data symbols to be transmitted may be transmitted through a DCI dynamic signaling. In addition, the transmitting device may also notify the receiving device of other information about the grouping in an explicit or implicit manner. In one example, information about the grouping standard of the data symbols to be transmitted may be transmitted. For example, it may be notified through the DCI dynamic signaling to the receiving end that the grouping standard of the data symbols to be transmitted is to group the data symbols to be transmitted on adjacent subcarriers into one group.

In one implementation, a parameter indicating grouping information may be added to a higher layer signaling, such as an RRC configuration signaling, and notified to the receiving device, and the parameter is used to indicate whether to perform symbol grouping. The parameter may be, for example, a reModuloBindingEnable field. For example, when the parameter has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the parameter has a value of 0, the foregoing grouping is not enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the linear/non-linear precoding configuration or indication is non-linear precoding; and the grouping may not be enabled when the linear/non-linear precoding configuration or indication is linear precoding.

In another example, parameters such as the grouping size on the frequency domain subcarrier, the time domain symbol, and the spatial domain layer may also be independently configured. For example, when a corresponding configuration of a domain is 1, the grouping may not be enabled in the corresponding domain. Specifically, for example, parameters (such as reModuloBindingSubcarrierSize, reModuloBindingSymbolSize, reModuloBindingLayerSize) may be added to the RRC configuration signaling and notified to the receiving device.

The selection unit 1420 selects a common modulo vector for each group of data symbols to be transmitted. In one example, the selection unit 1420 may select a modulo vector that minimizes the average power of the transmission symbols as the common modulo vector, wherein the transmission symbols are acquired after the modulo operation is performed on one group of data symbols to be transmitted. For example, pₖ and qₖ may be respectively expressed as:

$${P}_{k} = [ - \frac{{\sum }_{m = 1}^{M} Re \{ {x}_{k , m} \}}{\sqrt{α} M} ] \\ {q}_{k} = [ - \frac{{\sum }_{m = 1}^{M} Im \{ {x}_{k , m} \}}{\sqrt{α} M} ]$$

where M is the number of data symbols to be transmitted in one group, x_{k,m} is the m-th data symbol to be transmitted in one group of the k-th user, [x] is a rounding operation which may be a up rounding, a down rounding, or a rounding by minimum distance. Therefore, when the modulo vector that minimizes the average power of the transmission symbols is selected as the common modulo vector, wherein the transmission symbols are acquired after the modulo operation is performed on one group of data symbols to be transmitted, the above result may be calculated so that the following condition is satisfied:

$$min {\sum }_{m = 1}^{M} {‖ {x}_{k , m} + \sqrt{α} ( {p}_{k} + j {q}_{k} ) ‖}^{2}$$

where pₖ and qₖ are integers.

In addition, in another example, when selecting the common modulo vector for each group of data symbols to be transmitted, the selecting unit 1420 may select a modulo vector that minimizes the maximum power in the transmission symbols as the common modulo vector, wherein the transmission symbols are acquired after the modulo operation is performed on one group of transmission symbols. For example, at this time, pₖ and qₖ may be respectively expressed as:

$${P}_{k} = [ - \frac{max \{ Re \{ {x}_{k , m} \} {\vert}_{m} \} + min {\{ Re \{ {x}_{k , m} \} \vert}_{m} \}}{2 \sqrt{α}} ] \\ {q}_{k} = [ - \frac{max \{ Im \{ {x}_{k , m} \} {\vert}_{m} \} + min {\{ Im \{ {x}_{k , m} \} \vert}_{m} \}}{2 \sqrt{α}} ]$$

Therefore, when the modulo vector that minimizes the maximum power in the transmission symbols is selected as the common modulo vector, wherein the transmission symbols are acquired after the modulo operation is performed on one group of data symbols to be transmitted, the above result may be calculated so that the following condition is satisfied:

min∥Re{x_{k,m}+\sqrt{α}(pₖ+jqₖ)},Im{x_{k,m}+\sqrt{α}(pₖ+jqₖ)}∥_{∞}

Where pₖ and qₖ are integers, and ∥x₁, . . . , x_{M}∥_{∞} represents the infinite norm.

The processing unit 1430 may process each group of data symbols to be transmitted according to the selected common modulo vector to acquire the transmission symbols.

FIG. 7 shows a method for precoding one group of data symbols to be transmitted by selecting the common modulo vector according to one embodiment of the present disclosure, where the group of data symbols is composed of two data symbols to be transmitted. As shown in FIG. 7, the transmitting device performs the modulo operation on the two data symbols to be transmitted by using the common modulo vector (indicated by an arrow) to obtain two transmission symbols after the modulo operation. FIG. 8 shows a method for performing the modulo operation on two reception symbols in one group by using the common modulo vector to decode the two reception symbols according to one embodiment of the present disclosure. As shown in FIG. 8, at the receiving end of the receiving device, the common modulo vector is calculated, and the modulo operation is performed on the two reception symbols composed of the transmission symbol and the interference vector together by using the calculated common modulo vector, to acquire the data symbols to be transmitted that the transmitting device wishes to transmit.

In another implementation of the embodiment of the present disclosure, the processing unit of the transmitting device may further: determine a modulo boundary for a precoding modulo operation according to a transmission layer identifier corresponding to each group of data symbols to be transmitted; and the processing each group of data symbols to be transmitted according to the common modulo vector may further include: processing each group of data symbols to be transmitted according to the selected common modulo vector and the modulo boundary. Specifically, in the same group of data symbols to be transmitted, the determined modulo boundaries are the same; while in different groups of data symbols to be transmitted, the determined modulo boundaries may be different. For example, when the corresponding transmission layer identifier in the group of data symbols to be transmitted increases, the modulo boundary may be gradually reduced. Optionally, when the corresponding one or more transmission layer identifiers in one group of data symbol groups to be transmitted are less than or equal to a preset transmission layer identifier, the modulo boundary determined for the group of data symbols to be transmitted may be considered to be infinite, therefore the modulo operation may not be performed on the data symbols to be transmitted in the group of data symbols to be transmitted. The above method for determining the modulo boundary for the group of data symbols to be transmitted is merely an example. In practical applications, any method for determining the modulo boundary may be adopted, which is not restricted herein. FIG. 6 shows an example of determining the modulo boundary for the group of data symbols to be transmitted according to another embodiment of the present disclosure. As shown in FIG. 6, when the corresponding transmission layer identifier in the group of data symbols to be transmitted is 1-3, the modulo boundary α may be ∞, so that the modulo operation is not performed on the data symbols to be transmitted in the group of data symbols to be transmitted; when the corresponding transmission layer identifier in the group of data symbols to be transmitted is 4-6, the modulo boundary α may be 4; when the transmission layer identifier in the group of data symbols to be transmitted is greater than or equal to 7, the modulo boundary α may be 2.

After determining the modulo boundary, the data symbols to be transmitted may be processed according to the determined modulo boundary and the common modulo vector. The specific process of the modulo operation is explained and illustrated in detail in the above FIGS. 2 (a)-(d), and is not repeated herein.

Optionally, information about the determined modulo boundary may also be transmitted to a receiving end of the receiving device. Specifically, the information about the determined modulo boundary may be transmitted to the receiving end in an explicit or implicit manner. In one example, the information about the determined modulo boundary may be notified to the receiving end through, for example, DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is notified with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 (where α₁˜α₃ are positive real numbers).

In another example, the information about the determined modulo boundary may be represented by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is ∞; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above notification manner of the information about the modulo boundary is merely an example. In practical applications, any manner of notifying the modulo boundary may be adopted, which is not restricted herein.

Specifically, for the mapping scheme of the serial number of the DMRS port, one implementation is to add to the standard the following predefined mapping tables (such as Table 2 and Table 3) between the port and the constellation diagram modulo boundary.

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above manner for the DCI signaling configuration and the DMRS port mapping configuration are merely examples. In practical applications, any configuration and mapping manner of the modulo boundary may be adopted, which is not restricted herein.

It can be seen that, by using the transmitting device according to the embodiment of the present disclosure, it is possible to group the data symbols to be transmitted during the precoding process and determine the common modulo vector for processing according to the grouping. This grouping and processing manner on the data symbols to be transmitted may combine a plurality of symbols to perform joint precoding and decoding processing, thereby avoiding the problems of high error rate and low performance caused by independent decoding, improving the decoding accuracy and decoding efficiency, and enhancing the reliability of the system.

Hereinafter, a receiving device according to an embodiment of the present application is described with reference to FIG. 15. The receiving device may perform the above decoding method. Since operations of the receiving device are basically the same as the respective steps of the decoding method described above, it is only briefly described herein, and repeated description of the same content is omitted.

As shown in FIG. 15, the receiving device 1500 includes an acquiring unit 1510 and a processing unit 1520. It should be recognized that FIG. 15 only shows components related to the embodiment of the present application, and other components are omitted, but this is only schematic, and the receiving device 1500 may include other components as needed.

The acquiring unit 1510 acquires reception symbols and information about reception symbol grouping.

Specifically, the acquiring unit 1510 may receive the information about the reception symbol grouping. For example, the receiving device may receive the information about the number of symbols contained in each group of reception symbols in an explicit or implicit manner. For example, the information that each group of data symbols to be transmitted includes 2 or 4 data symbols to be transmitted may be received through a DCI dynamic signaling. In addition, the receiving device may also receive other information about the grouping in an explicit or implicit manner. In one example, information about the grouping standard of the data symbols to be transmitted may be received. For example, it may be learned through the DCI dynamic signaling to the receiving end that the grouping standard of the data symbols to be transmitted is to group the data symbols to be transmitted on adjacent subcarriers into one group.

In one implementation, the transmitting device may add a parameter indicating grouping information may to a higher layer signaling, such as an RRC configuration signaling, and notified to the receiving device, and the parameter is used to indicate whether to perform symbol grouping. The parameter may be, for example, a reModuloBindingEnable field. For example, when the parameter received by the receiving device has a value of 1, the foregoing grouping may be enabled, where one or more of the parameters such as a grouping size on a frequency domain subcarrier, a time domain symbol, and a spatial domain layer may be agreed in the standard, or may be notified together to the receiving device through the higher layer signaling. When the received parameter has a value of 0, the foregoing grouping may not be enabled.

In one example, the parameter used to indicate the grouping information may also be implicitly notified to the receiving device. For example, when a linear/non-linear precoding configuration or indication signaling exists in the system, the above parameter may be indicated simultaneously with the linear/non-linear precoding configuration or indication signaling. For instance, the grouping may be enabled when the received linear/non-linear precoding configuration or indication is non-linear precoding; and the grouping is not enabled when the received linear/non-linear precoding configuration or indication is linear precoding.

In another example, parameters such as the grouping size on the frequency domain subcarrier, the time domain symbol, and the spatial domain layer may also be independently configured. For example, when a received corresponding configuration of a domain is 1, the grouping may not be enabled in the corresponding domain. Specifically, for example, parameters (such as reModuloBindingSubcarrierSize, reModuloBindingSymbolSize, reModuloBindingLayerSize) may be added to the RRC configuration signaling and notified to the receiving device.

The processing unit 1520 processes each group of reception symbols by using a common modulo vector for each group of reception symbols according to the information of the reception symbol grouping to acquire the data symbols to be transmitted.

When the reception signal is detected by using the common modulo vector of each group of reception symbol, in one example, pₖ and qₖ in the modulo vector may be used as unknown parameters, while the reception symbols may be used as uniformly distributed random variables, to first detect pₖ and qₖ, followed by a symbol detection by using a commonly used MIMO detector. For detection of pₖ and qₖ, a maximum likelihood detection may be performed by employing a likelihood function shown in the following formula.

$$log p ( y \vert {p}_{k} , {q}_{k} ) = {\sum }_{m = 1}^{M} log ( {\sum }_{n = 1}^{{N}_{c}} exp ( - \frac{{‖ {y}_{k , m} - {\overline{h}}_{k , m} ( {c}_{n} + \sqrt{α} ( {p}_{k} + j {q}_{k} ) ) ‖}^{2}}{{σ}^{2}} ) )$$

where N_{c} is the number of constellation points in the modulation constellation diagram, y_{k,m} is the reception signal of the m-th data symbol in one group corresponding to the k-th user, and h̅_{k,m} is an equivalent reception channel measured by a user corresponding to the symbol, and cₙ is the constellation point.

In one implementation of the present disclosure, the processing unit 1520 may further: acquire information about a modulo boundary, the modulo boundary being determined by a transmission layer identifier corresponding to each group of reception symbols; and the processing each group of reception symbols by using the common modulo vector of each group of reception symbols may further include: processing each group of data symbols to be transmitted according to the common modulo vector and the modulo boundary. Specifically, the receiving device may acquire the information about the modulo boundary. In one example, the information about the determined modulo boundary may be acquired in an explicit or implicit manner. In one example, the information about the modulo boundary may be acquired, for example, through DCI dynamic signaling. For example, a respective correspondence between two bits in the DCI and four selectable α values of the modulo boundary may be configured at a transmitting end and the receiving end in advance, so that in the dynamic signaling, the specific selection content in the pre-configured α value is acquired with these two bits in the DCI. The correspondence between the bits in the DCI and the α value may be configured in a variety of ways, for example, it may be pre-configured through standards, and may be quasi-statically configured through higher level signaling, and may also be set by one of the transmitting device or the receiving device and notified to the other device in advance, which is not restricted herein. For example, a parameter with a length of 2 bits regarding the modulo boundary may be added in a control signaling (such as in DCI) indicating data transmission, and the parameter is used to indicate a constellation diagram modulo boundary indicating field for indicating different modulo boundaries, a meaning of the bits of the modulo boundary may be shown in Table 1 (where α₁˜α₃ are positive real numbers).

In another example, the information about the determined modulo boundary may be acquired by using a serial number of a port (e.g., a serial number of a DMRS port) where the transmission symbols are located. For example, a mapping relationship between the modulo boundary and a corresponding serial number of the DMRS port may be pre-configured, so that the transmitting device informs the receiving end of its selected modulo boundary by using the serial number of the DMRS port where the transmission symbols are located, when transmitting the transmission symbols from the transmitting end. In the example, a mapping relationship among the modulo boundary, the corresponding serial number of the DMRS port, and the corresponding transmission layer identifier may also be configured in a variety of ways, for example, it may be pre-configured through standards, and may be quasi-statically configured through higher level signaling, and may also be set by one of the transmitting device or the receiving device and notified to the other device in advance, which is not restricted herein. For example, in an example of 8 DMRS ports, serial numbers 1-3 of the DMRS port may be used to indicate that the α value is ∞; a serial number 4 of the DMRS port may be used to indicate that the α value is a first value, such as 8; serial numbers 5-6 of the DMRS port may be used to indicate that the α value is a second value, such as 4; serial numbers 7-8 of the DMRS port may be used to indicate that the α value is a third value, such as 2. The above acquiring manner of the information about the modulo boundary is merely an example. In practical applications, any manner of acquiring the modulo boundary may be adopted, which is not restricted herein.

Specifically, for the mapping scheme of the serial number of the DMRS port, one implementation is to add to the standard the following predefined mapping tables (such as Table 2 and Table 3) between the port and the constellation diagram modulo boundary.

The transmitting device may configure the receiving device to use one of the above two mapping tables through higher level signaling such as RRC signaling. For example, an indication parameter regarding the mapping table may be added to an RRC configuration, and the parameter is used to indicate whether a currently used mapping table is Table 2 or Table 3, and the parameter may be, for example, a pdschModuloBoundTable field. For another example, the mapping table currently used may also be notified to the receiving device by means of MAC CE or the like.

In another implementation, the modulo boundary corresponding to each DMRS port may be notified to the user on a per-port or per-group-of-ports basis through higher level signaling. For example, the parameter regarding the modulo boundary may be added in the RRC configuration signaling, and the parameter is used to indicate the constellation diagram modulo boundary indicating field (such as pdschModuloBoundDmrsPort1000˜pdschModuloBoundDmrsPort1011 configuration fields), where the value of each field may be as shown in Table 1.

The above manner for the DCI signaling configuration and the DMRS port mapping configuration are merely examples. In practical applications, any configuration and mapping manner of the modulo boundary may be adopted, which is not restricted herein.

Further, the processing unit 1520 may process the reception symbols according to the modulo boundary in combination with the common modulo vector of each group of reception symbols to acquire the data symbols to be transmitted. Specifically, when the modulo boundary is determined to be ∞, the modulo operation may not be performed on the group of reception symbols; and when the modulo boundary is not ∞, the modulo operation may be performed on the group of reception symbols according to the determined modulo boundary to acquire the data symbol aₖ to be transmitted. The specific process of the modulo operation is explained and illustrated in detail in the foregoing FIGS. 3 (a)-(b), and is not repeated herein.

It can be seen that, by using the receiving device according to the embodiment of the present disclosure, it is possible to group the reception symbols during the decoding process and determine the common modulo vector for processing according to the grouping. This grouping and processing manner on the reception symbols may combine a plurality of symbols to perform joint decoding processing, thereby avoiding the problems of high error rate and low performance caused by independent decoding, improving the decoding accuracy and decoding efficiency, and enhancing the reliability of the system.

<Hardware>

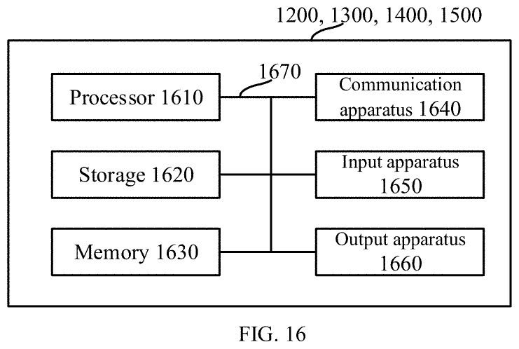

For example, the transmitting device and receiving device and the like in one implementation of the present invention can function as a computer that executes processing of the wireless communication method of the present invention. FIG. 16 is a diagram illustrating an example of a hardware configuration of related transmitting device and receiving device according to one implementation of the present invention. The above described transmitting devices 1200, 1400 and receiving devices 1300, 1500 may be physically designed as a computer apparatus including a processor 1610, a storage 1620, a memory 1630, a communication apparatus 1640, an input apparatus 1650, an output apparatus 1660, and a bus 1670 and the like.

It should be noted that, in the following description, the word “apparatus” may be replaced by “circuit”, “device”, “unit” and so on. It should be noted that the hardware structures of the transmitting devices 1200, 1400 and receiving devices 1300, 1500 may be designed to include one or more of each apparatus shown in the drawings, or may be designed not to include part of the apparatus.

For example, although only one processor 1610 is shown, a plurality of processors may be provided. Furthermore, processes may be implemented with one processor, or processes may be implemented either simultaneously or in sequence, or in different manners, on two or more processors. It should be noted that the processor 1610 may be implemented with one or more chips.

Each function of the transmitting devices 1200, 1400 and receiving devices 1300, 1500 is implemented by reading predetermined software (program) on hardware such as the processor 1610 and the memory 1620, so as to make the processor 1610 perform calculations, and by controlling the communication carried out by the communication apparatus 1640, and the reading and/or writing of data in the memory 1620 and the storage 1630.

The processor 1610 may control the whole computer by, for example, running an operating system. The processor 1610 may be configured with a central processing unit (CPU), which includes interfaces with peripheral apparatus, control apparatus, computing apparatus, a register and so on.

Furthermore, the processor 1610 reads programs (program codes), software modules or data, from the storage 1630 and/or the communication apparatus 1640, into the memory 1620, and executes various processes according to these. As for the programs, programs to allow computers to execute at least part of the operations of the above-described embodiments may be used.

The memory 1620 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1620 may be referred to as a “register”, a “cache”, a “main memory” (primary storage apparatus) and so on. The memory 1620 can store executable programs (program codes), software modules and so on for implementing the wireless communication methods according to embodiments of the present invention.

The storage 1630 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1630 may be referred to as “secondary storage apparatus.”

The communication apparatus 1640 is hardware (transmitting/receiving device) for allowing inter-computer communication by using wired and/or wireless networks, and may be referred to as, for example, a “network device”, a “network controller”, a “network card”, a “communication module” and so on. The communication apparatus 1640 may be configured to include a high frequency switch, a duplexer, a filter, a frequency synthesizer and so on in order to realize, for example, frequency division duplex (FDD) and/or time division duplex (TDD).

The input apparatus 1650 is an input device for receiving input from the outside (for example, a keyboard, a mouse, a microphone, a switch, a button, a sensor and so on). The output apparatus 1660 is an output device for allowing sending output to the outside (for example, a display, a speaker, an LED (Light Emitting Diode) lamp and so on). It should be noted that the input apparatus 1650 and the output apparatus 1660 may be provided in an integrated structure (for example, a touch panel).

Furthermore, these pieces of apparatus, including the processor 1610, the memory 1620 and so on are connected by the bus 1670 so as to communicate information. The bus 1670 may be formed with a single bus, or may be formed with buses that vary between pieces of apparatus.

Also, the transmitting devices 1200, 1400 and receiving devices 1300, 1500 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1610 may be installed with at least one of these pieces of hardware.

<Variation>

In addition, the terms illustrated in the present specification and/or the terms required for the understanding of the present specification may be substituted with terms having the same or similar meaning. For example, a channel and/or a symbol may be a signal. In addition, the signal may be a message. A reference signal may be abbreviated as an “RS (Reference Signal)”, and may be referred to as a “pilot”, a “pilot signal” and so on, depending on which standard applies. In addition, a component carrier (CC) may be referred to as a carrier frequency, a cell, or the like.

In addition, the wireless frame may be composed of one or more periods (frames) in the time domain. Each of the one or more periods (frames) constituting the wireless frame may also be referred to as a subframe. Further, a subframe may be composed of one or more slots in the time domain. The subframe may be a fixed length of time duration (eg, 1 ms) that is independent of the numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Furthermore, the slot may also be a time unit configured based on parameter. Furthermore, a slot may also include multiple microslots. Each microslot may be comprised of one or more symbols in the time domain. Furthermore, a microslot may also be referred as “a subframe”.

A wireless frame, a subframe, a slot, a microslot and a symbol all represent the time unit when transmitting signals. A wireless frame, a subframe, a slot, a microslot and a symbol may also use other names that correspond to each other. For example, one subframe may be referred to as a “transmission time interval (TTI)”, and a plurality of consecutive subframes may also be referred to as a “TTI”, and one slot or one microslot may also be referred to as a “TTI.” That is, a subframe and/or a TTI may be a subframe (1 ms) in existing LTE, may be a shorter period than 1 ms (for example, one to thirteen symbols), or may be a longer period of time than 1 ms. It should be noted that a unit indicating a TTI may also be referred to as a slot, a microslot, or the like instead of a subframe.

Here, a TTI refers to the minimum time unit of scheduling in wireless communication, for example. For example, in LTE systems, a wireless base station schedules the wireless resources (such as the frequency bandwidth and transmission power that can be used in each user terminal) to allocate to each user terminal in TTI units. It should be noted that the definition of TTIs is not limited to this.

TTIs may be channel-coded data packets (transport blocks), code blocks, and/or codeword transmission time units, or may be the unit of processing in scheduling, link adaptation and so on. It should be noted that, when a TTI is given, the time interval (e.g., the number of symbols) actually mapped to the transport block, code block, and/or codeword may also be shorter than the TTI.

It should be noted that, when one slot or one microslot is called a TTI, more than one TTI (i.e., more than one slot or more than one microslot) may also become the scheduled minimum time unit. Furthermore, the number of slots (the number of microslots) constituting the minimum time unit of the scheduling may be controlled.

A TTI having a time duration of 1 ms may be referred to as a “normal TTI” (TTI in LTE Rel. 8 to 12), a “standard TTI”, a “long TTI”, a “normal subframe”, a “standard subframe”, or a “long subframe”, and so on. A TTI that is shorter than a normal TTI may be referred to as a “shortened TTI”, a “short TTI”, a “partial (or fractional) TTI”, a “shortened subframe”, a “short subframe”, a “microslot”, or a “short microslot” and so on.

It should be noted that, a long TTI (eg, a normal TTI, a subframe, etc.) may be replaced with a TTI having a time duration exceeding 1 ms, and a short TTI (eg, a shortened TTI, and so on) may also be replaced with a TTI having a TTI duration shorter than the long TTI and a TTI duration exceeding 1 ms.

A resource block (RB) is the unit of resource allocation in the time domain and the frequency domain, and may include one or a plurality of consecutive subcarriers in the frequency domain. Also, an RB may include one or more symbols in the time domain, and may be one slot, one microslot, one subframe or one TTI duration. One TTI and one subframe each may be comprised of one or more resource blocks, respectively. It should be noted that one or more RBs may also be referred to as a “physical resource block (PRB (Physical RB))”, a “SubCarrier Group (SCG)”, a “Resource Element Group (REG)”, a “PRG pair”, an “RB pair” and so on.

Also, a resource block may also be composed of one or more resource elements (RE). For example, one RE can be a wireless resource area of a subcarrier and a symbol.

It should be noted that the above-described structures of wireless frames, subframes, slots, microslots and symbols and so on are simply examples. For example, configurations such as the number of subframes included in a wireless frame, the number of slots of each subframe or wireless frame, the number or microslots included in a slot, the number of symbols and RBs included in a slot or microslot, the number of subcarriers included in an RB, the number of symbols in a TTI, the symbol duration and the cyclic prefix (CP) duration can be variously changed.

Also, the information and parameters and so on described in this specification may be represented in absolute values or in relative values with respect to predetermined values, or may be represented in corresponding other information. For example, radio resources may be indicated by predetermined indices. In addition, equations to use these parameters and so on may be used, apart from those explicitly disclosed in this specification.

The names used for parameters and so on in this specification are not limited in any respect. For example, since various channels (PUCCH (Physical Uplink Control Channel), PDCCH (Physical Downlink Control Channel) and so on) and information elements can be identified by any suitable names, the various names assigned to these various channels and information elements are not limited in any respect.

The information, signals and so on described in this specification may be represented by using any one of various different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, in a memory), or may be managed in a control table. The information, signals and so on that are input and/or output may be overwritten, updated or appended. The information, signals and so on that are output may be deleted. The information, signals and so on that are input may be transmitted to other apparatus.

Reporting of information is by no means limited to the aspects/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

It should be noted that physical layer signaling may also be referred to as L1/L2 (Layer 1/Layer 2) control information (L1/L2 control signals), L1 control information (L1 control signal) and so on. Also, RRC signaling may be referred to as “RRC messages”, and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, a reporting “X”) does not necessarily have to be carried out explicitly, and can be carried out implicitly (by, for example, not reporting this piece of information, or by reporting a different piece of information).

Regarding decisions, which may be made in values represented by one bit (0 or 1), may be made by a true or false value (Boolean value) represented by true or false, or may be made by comparing numerical values (for example, comparison against a predetermined value).

Software, whether referred to as “software”, “firmware”, “middleware”, “microcode” or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are included in the definition of communication media.

The terms “system” and “network” as used herein are used interchangeably.

In the present specification, the terms “radio base station (BS)”, “radio base station”, “eNB”, “gNB”, “cell”, “sector”, “cell group”, “carrier” and “component carrier” may be used interchangeably. A base station may be referred to as a “fixed station”, “NodeB”, “eNodeB (eNB)”, “access point”, “transmission point”, “receiving point”, “femto cell”, “small cell” and so on.

A radio base station can accommodate one or more (for example, three) cells (also referred to as “sectors”). When a radio base station accommodates a plurality of cells, the entire coverage area of the base station can be partitioned into a plurality of smaller areas, and each smaller area can provide communication services with radio base station subsystems (for example, indoor small radio base stations (RRHs (Remote Radio Heads))). The term “cell” or “sector” refers to part or all of the coverage area of a radio base station and/or a b radio ase station subsystem that provides communication services within this coverage.

In the present specification, the terms “mobile station (MS)”, “user terminal”, “user equipment (UE)” and “terminal” may be used interchangeably. Radio base stations are sometimes referred to by terms such as fixed station, NodeB, eNodeB (eNB), access point, transmission point, reception point, femto cell, and small cell, and the like.

A mobile station is also sometimes used by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

In addition, the transmitting devices 1100, 1300 and the receiving devices 1200, 1400 in this specification may be replaced by radio base stations or user terminals.

In the present specification, it is assumed that certain actions to be performed by radio base station may, in some cases, be performed by its higher node (upper node). In a network comprised of one or more network nodes with radio base stations, it is clear that various operations that are performed to communicate with terminals can be performed by radio base stations, one or more network nodes (for example, MMES (Mobility Management Entities), S-GW (Serving-Gateways), and so on may be possible, but these are not limiting) other than radio base stations, or combinations of these.

The respective aspects/embodiments illustrated in this specification may be used individually or in combinations, which may also be switched and used during execution. The order of processes, sequences, flowcharts and so on of the respective aspects/embodiments described in the present specification may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000 (Code Division Multiple Access), UMB (Ultra Mobile Broadband), IEEE 802.11 (Wi-Fi (registered trademark)), IEEE 802.16 (WiMAX (registered trademark)), IEEE 920.20, UWB (Ultra-WideBand), Bluetooth (registered trademark) and other adequate radio communication methods, and/or next-generation systems that are enhanced based on these.

The phrase “based on” as used in this specification does not mean “based only on”, unless otherwise specified. In other words, the phrase “based on” means both “based only on” and “based at least on.”

Any reference to elements with designations such as “first”, “second” and so on as used herein does not generally limit the number/quantity or order of these elements. These designations are used only for convenience, as a method of distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled”, or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access.” As used herein, two elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in radio frequency fields, microwave regions and optical (both visible and invisible) regions.

When terms such as “including”, “comprising” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1.-18. (canceled)

19. A transmitting device, comprising:
an acquiring unit configured to acquire data symbols to be transmitted and a transmission layer identifier corresponding to the data symbols to be transmitted;
a determining unit configured to determine a modulo boundary for a precoding modulo operation according to the transmission layer identifier corresponding to the data symbols to be transmitted;
a processing unit configured to process, according to the determined modulo boundary, the data symbols to be transmitted to acquire transmission symbols.

20. A receiving device, comprising:
an acquiring unit configured to acquire reception symbols and information about a modulo boundary, the modulo boundary being determined by a transmission layer identifier corresponding to the reception symbols;
a processing unit configured to process, according to the modulo boundary, the reception symbols to acquire data symbols to be transmitted.

21. A transmitting device, comprising:
a grouping unit configured to group data symbols to be transmitted;
a selecting unit configured to select a common modulo vector for each group of data symbols to be transmitted;
a processing unit configured to process, according to selected common modulo vector, each group of data symbols to be transmitted to acquire transmission symbols.

22. (canceled)

23. The transmitting device according to claim 19, wherein:
data transmitted by the transmitting device to a receiving device is transmitted through a plurality of transmission layers, and the plurality of transmission layers include one or more transmission layer groups;
the transmission layer identifier and the modulo boundary determined by the determining unit are identical in a same transmission layer group.

24. The transmitting device according to claim 19, wherein when the transmission layer identifier increases, the modulo boundary determined by the determining unit decreases.

25. The transmitting device according to claim 19, wherein:
the modulo boundary determined by the determining unit causes a power of the acquired transmission symbols to satisfy a preset condition, after the data symbols to be transmitted corresponding to the transmission layer identifier are processed according to the modulo boundary.

26. The transmitting device according to claim 19, wherein the modulo operation is not performed on the data symbols to be transmitted by the processing unit when the transmission layer identifier corresponding to the data symbols to be transmitted is less than or equal to a preset transmission layer identifier.

27. The transmitting device according to claim 19, wherein the transmitting device further includes:
a transmitting unit, configured to transmit information about the determined modulo boundary.

28. The transmitting device according to claim 27, wherein
the transmitting unit transmits the information about the determined modulo boundary through signaling; or
represents the information about the determined modulo boundary by a serial number of a DMRS port where the transmission symbols are located.

29. The transmitting device according to claim 28, wherein the transmitting unit adds a parameter about the modulo boundary to a DCI signaling, the parameter is used to indicate the determined modulo boundary.

30. The transmitting device according to claim 28, wherein
the transmitting unit selects a currently used mapping table from preset one or more mapping tables, the mapping table is used to indicate a mapping relationship between the serial number of the DMRS port and the determined modulo boundary.

31. The receiving device according to claim 20, wherein the acquiring unit acquires the information about the modulo boundary through signaling; or acquires the information about the modulo boundary by a serial number of a DMRS port where the transmission symbol is located.

32. The transmitting device according to claim 21, wherein:
the processing unit determines a modulo boundary for a precoding modulo operation according to a transmission layer identifier corresponding to each group of data symbols to be transmitted;
processes each group of data symbols to be transmitted according to the selected common modulo vector and the modulo boundary.

33. The transmitting device according to claim 21, wherein the transmitting device further includes:
a transmitting unit, configured to transmit information about the number of symbols contained in each group of data symbols to be transmitted.

34. The transmitting device according to claim 21, wherein
the grouping unit groups the data symbols to be transmitted which are transmitted on adjacent transmission layers into one group;
groups the data symbols to be transmitted which are transmitted on adjacent subcarriers into one group; or
groups the data symbols to be transmitted which are transmitted on adjacent time domain symbols into one group.

35. The transmitting device according to claim 21, wherein
the selecting unit selects a modulo vector that minimizes an average power of transmission symbols as the common modulo vector, wherein the transmission symbols are acquired after perform modulo operation on one group of data symbols to be transmitted; or
selects a modulo vector that minimizes a maximum power in the transmission symbols as the common modulo vector, wherein the transmission symbols after perform modulo operation on one group of transmission symbols.
